(19) United States
(12) Patent Application Publication
(10) Pub. No.: US 2026/0247441 A1
(43) Pub. Date: Aug. 20, 2026

(54) METHOD AND DEVICE FOR NEGOTIATION BETWEEN MULTIPLE ACCESS POINTS IN WI-FI COMMUNICATION

(71) Applicant: Samsung Electronics Co., Ltd., Suwon-si (KR)

(72) Inventors: Jonghoe KOO, Suwon-si (KR); Jinho CHOI, Suwon-si (KR); Taeyoung HA, Suwon-si (KR); Seongho BYEON, Suwon-si (KR)

(21) Appl. No.: 19/536,789

(22) Filed: Feb. 11, 2026

(30) Foreign Application Priority Data
Feb. 14, 2025 (KR) 10-2025-0019705

(51) Int. Cl. H04W 74/0816; H04W 72/23; H04W 74/0808; H04W 84/12

(52) U.S. Cl. CPC H04W 74/0816; H04W 72/23; H04W 74/0808; H04W 84/12

(57) ABSTRACT

A method performed by a first access point (AP) in a wireless local area network (WLAN) communication system is provided. The method includes transmitting, to a second AP, a multi-AP coordination (MAPC) negotiation request frame for a coordinated-time division multiple access (Co-TDMA) agreement, wherein the MAPC negotiation request frame includes Co-TDMA operation related information; and receiving, from the second AP, an MAPC negotiation response frame for the Co-TDMA agreement, in response to the MAPC negotiation request frame, wherein the Co-TDMA operation related information includes bandwidth information of the first AP.

### CROSS-REFERENCE TO RELATED APPLICATION(S)

This application is based on and claims priority under 35 U.S.C. § 119 (a) of a Korean patent application number 10-2025-0019705, filed on Feb. 14, 2025, in the Korean Intellectual Property Office, the disclosure of which is incorporated by reference herein in its entirety.

### BACKGROUND

### 1. Field

The disclosure relates to Wi-Fi communication between electronic devices. More particularly, the disclosure relates to a method and device for negotiation between multiple access points in Wi-Fi communication.

### 2. Description of Related Art

Recently, due to the development of wireless technology, wired networks used by many people are being replaced by wireless networks. In other words, since the mobility constraints of wired networks may be solved with wireless technology, many technologies using wireless networks are being actively researched.

A wireless local area network (WLAN), also called Wi-Fi, allows the use of the internet through portable terminals or notebooks within a predetermined distance from where an access point (AP) is installed. The Wi-Fi Alliance defines Wi-Fi as wireless local area network (WLAN) products based on Institute of Electrical and Electronics Engineers (IEEE) 802.11 standards. Wi-Fi communication primarily uses the 2.4 GHz and 5 GHz wireless bands. In particular, with the popularization of mobile terminals, wireless LANs with potential as open wireless networks are rapidly extending, and Wi-Fi is used to provide high-speed data services throughout cities including schools, airports, hotels, and offices.

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. IoT may be applied to fields such as smart homes, smart buildings, smart cities, smart cars or connected cars, smart grids, healthcare, smart appliances, and advanced medical services through convergence and combination between existing information technology (IT) and various industries.

Meanwhile, an efficient cooperation mechanism between APs is essential to maximize network performance in a multi-access point (AP) environment. In existing wireless LAN systems, since each AP performs scheduling independently, there is a possibility of increased interference and inefficient distribution of transmission opportunities in a multi-AP environment. In particular, collisions between APs sharing the same frequency band may cause data transmission delays and decreased throughput. Therefore, there is a need for a method and device for minimizing interference and efficiently coordinating transmission opportunities through negotiation between multiple APs.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for negotiation between multiple access points during Wi-Fi communication.

Another aspect of the disclosure is to provide a method and device for negotiation in coordinated-time division multiple access (Co-TDMA) operations between multiple access points during Wi-Fi communication.

Additional aspects will be set forth in part in the description which follows and, in part, will be apparent from the description, or may be learned by practice of the presented embodiments.

In accordance with an aspect of the disclosure, a method performed by a first access point (AP) in a wireless local area network (WLAN) communication system is provided. The method includes transmitting, to a second AP, a multi-AP coordination (MAPC) negotiation request frame for a coordinated-time division multiple access (Co-TDMA) agreement, wherein the MAPC negotiation request frame includes Co-TDMA operation related information, and receiving, from the second AP, an MAPC negotiation response frame for the Co-TDMA agreement, in response to the MAPC negotiation request frame, wherein the Co-TDMA operation related information includes bandwidth information of the first AP, and wherein the bandwidth information of the first AP includes channel width information indicating basic service set (BSS) bandwidth of the first AP and information on a channel center frequency segment (CCFS) indicating a channel center frequency for the BSS bandwidth of the first AP.

In accordance with another aspect of the disclosure, a method performed by a second access point (AP) in a wireless local area network (WLAN) communication system is provided. The method includes receiving, from a first AP, a multi-AP coordination (MAPC) negotiation request frame for a coordinated-time division multiple access (Co-TDMA) agreement, wherein the MAPC negotiation request frame includes Co-TDMA operation related information, and transmitting, to the first AP, an MAPC negotiation response frame for the Co-TDMA agreement, in response to the MAPC negotiation request frame, wherein the Co-TDMA operation related information includes bandwidth information of the first AP, and wherein the bandwidth information of the first AP includes channel width information indicating basic service set (BSS) bandwidth of the first AP and information on a channel center frequency segment (CCFS) indicating a channel center frequency for the BSS bandwidth of the first AP.

In accordance with another aspect of the disclosure, a first access point (AP) in a wireless local area network (WLAN) communication system is provided. The first access point includes at least one transceiver; at least one processor communicatively coupled to the at least one transceiver; and at least one memory, communicatively coupled to the at least one processor, storing instructions executable by the at least one processor individually or in any combination to cause the first AP to: transmit, to a second AP, a multi-AP coordination (MAPC) negotiation request frame for a coordinated-time division multiple access (Co-TDMA) agreement, wherein the MAPC negotiation request frame includes Co-TDMA operation related information; and receive, from the second AP, an MAPC negotiation response frame for the Co-TDMA agreement, in response to the MAPC negotiation request frame, wherein the Co-TDMA operation related information includes bandwidth information of the first AP, and wherein the bandwidth information of the first AP includes channel width information indicating basic service set (BSS) bandwidth of the first AP and information on a channel center frequency segment (CCFS) indicating a channel center frequency for the BSS bandwidth of the first AP.

In accordance with another aspect of the disclosure, a second access point (AP) in a wireless local area network (WLAN) communication system is provided. The second access point includes at least one transceiver; at least one processor communicatively coupled to the at least one transceiver; and at least one memory, communicatively coupled to the at least one processor, storing instructions executable by the at least one processor individually or in any combination to cause the second AP to: receive, from a first AP, a multi-AP coordination (MAPC) negotiation request frame for a coordinated-time division multiple access (Co-TDMA) agreement, wherein the MAPC negotiation request frame includes Co-TDMA operation related information, and transmit, to the first AP, an MAPC negotiation response frame for the Co-TDMA agreement, in response to the MAPC negotiation request frame, wherein the Co-TDMA operation related information includes bandwidth information of the first AP, and wherein the bandwidth information of the first AP includes channel width information indicating basic service set (BSS) bandwidth of the first AP and information on a channel center frequency segment (CCFS) indicating a channel center frequency for the BSS bandwidth of the first AP.

According to an embodiment, by proposing a method for negotiating Co-TDMA operations between multiple access points, there are effects such as network resource conservation, interference and delay reduction, and flexible configuration management.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an example of a short-range communication connection form of an electronic device and an access point according to an embodiment of the disclosure;

FIG. 2 is a view illustrating operations of an access point (AP) and a station (STA) for establishing wireless LAN access according to an embodiment of the disclosure;

FIG. 3 is a view illustrating an example of a short-range communication connection form of an electronic device according to an embodiment of the disclosure;

FIG. 4 is a view illustrating an example of a frame structure used in an IEEE 802.11 system according to an embodiment of the disclosure;

FIG. 5 is a view illustrating an example of network allocation vector (NAV) setting according to an embodiment of the disclosure;

FIG. 6 is a view illustrating an example of transmission opportunity (TXOP) according to an embodiment of the disclosure;

FIG. 7 is a view illustrating an example of non-primary channel access (NPCA) according to an embodiment of the disclosure;

FIG. 8 is a view illustrating an example of dynamic subchannel operation (DSO) according to an embodiment of the disclosure;

FIG. 9 is a view illustrating an example of a configuration of a Multi-AP (access point) Coordination framework of a wireless LAN system according to an embodiment of the disclosure;

FIG. 10 is a view illustrating an example of an operation of Co-TDMA of a wireless LAN system according to an embodiment of the disclosure;

FIG. 11 is a view illustrating an example of Co-TDMA or triggered TXOP sharing (TXS) operation according to an embodiment of the disclosure;

FIG. 12 is a view illustrating an example of TXS operation with DSO proposed according to an embodiment of the disclosure;

FIG. 13 is a view illustrating an example of negotiation/agreement operation for periodic Co-TDMA operation between access points according to an embodiment of the disclosure;

FIGS. 14A and 14B are diagrams describing an example of a periodic Co-TDMA Request element format including Co-TDMA operation related information according to various embodiments of the disclosure;

FIGS. 15A, 15B, and 15C are views illustrating an action frame according to various embodiments of the disclosure;

FIGS. 16A, 16B, and 16C are views illustrating an example of an Action field format of an action frame according to various embodiments of the disclosure;

FIG. 17A is a view illustrating an example of a UHR Operation element format according to an embodiment of the disclosure;

FIG. 17B is a view illustrating an example of a UHR Operation Parameters field format according to an embodiment of the disclosure;

FIGS. 18A and 18B are diagrams describing an example of a UHR Operation element format that may include Co-TDMA operation related information according to various embodiments of the disclosure;

FIGS. 19A and 19B are views illustrating an example of a MAP Operation Parameter field format for Co-TDMA related negotiation according to various embodiments of the disclosure;

FIGS. 20A, 20B, 20C, 20D, and 20E are views illustrating an example of a Co-TDMA Request element format that may be included in a MAP Operation Parameter field format of an action frame including Co-TDMA related information according to various embodiments of the disclosure;

FIGS. 21A, 21B, 21C, and 21D are views illustrating an example of a Bandwidth Indication element format including Co-TDMA related information according to various embodiments of the disclosure;

FIGS. 22A, 22B, and 22C are views illustrating an example of a Co-TDMA Response element format that may be included in a MAP Operation Parameter field format of an action frame including Co-TDMA related information according to various embodiments of the disclosure;

FIG. 23 is a flowchart illustrating an operation of a first access point according to an embodiment of the disclosure; and

FIG. 24 is a flowchart illustrating an operation of a second access point according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart.

Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

Unless otherwise stated, in the description of an embodiment, “greater than or equal to” may be replaced with “greater than”, and “greater than” may be replaced with “greater than or equal to”. Unless otherwise stated, in the description of an embodiment, “less than or equal to” may be replaced with “less than”, and “less than” may be replaced with “less than or equal to”.

As used herein, the term ‘station,’ ‘terminal,’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

The embodiments are described below in relation to wireless local area network (WLAN) systems merely for simplicity. It should be understood that the embodiments are equally applicable to other wireless networks (e.g., cellular networks, pico networks, femto networks, satellite networks) as well as systems using signals of one or more wired standards or protocols (e.g., Ethernet and/or HomePlug/PLC standards). As used herein, the terms “WLAN” and “Wi-Fi®” may include communications governed by the IEEE 802.11 family of standards, BLUETOOTH®, HiperLAN (a set of wireless standards mainly used in Europe and comparable to IEEE 802.11 standards), and other technologies having relatively short wireless propagation ranges. Therefore, the terms “WLAN” and “Wi-Fi” may be used interchangeably herein. Further, while an infrastructure WLAN system including one or more access points (APs) and multiple wireless stations (STAs) is described below, the embodiments are equally applicable to other WLAN systems including, e.g., multiple WLANs, peer-to-peer (or independent basic service set) systems, Wi-Fi Direct systems and/or hotspots.

Further, while the exchange of data frames between wireless devices is described herein, the embodiments may be applied to the exchange of any data unit, packet and/or frame between wireless devices. Therefore, the term “frame” may include any frame, packet, or data unit such as, e.g., protocol data units (PDUs), media access control (MAC) protocol data units (MPDUs), and physical (PHY) layer convergence procedure protocol data units (PPDUs). The term “A-MPDU” may mean aggregated MPDUs.

In the following description, numerous specific details are set forth, such as examples of specific components, circuits, and processes, to provide a thorough understanding of the disclosure. The term “connected” used herein means directly connected or connected through one or more intervening components or circuits. The term “associated access point” means an access point with which a given station is currently associated and/or connected (e.g., a communication channel or link established between the access point and the given station is present). Further, in the following description and for purposes of description, specific nomenclature is set forth to provide a thorough understanding of the embodiments. However, it is apparent to those skilled in the art that these specific details may not be necessary to practice the embodiments. In other instances, well-known circuits and devices are illustrated in block diagram form to avoid obscuring the disclosure.

The terminology used herein is provided for a better understanding of the disclosure, and changes may be made thereto without departing from the technical spirit of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

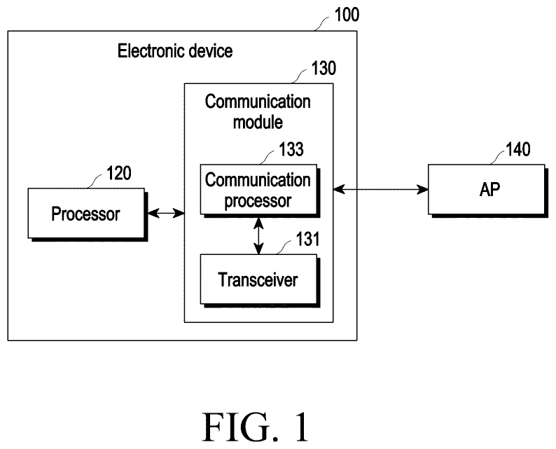

FIG. 1 is a view illustrating a short-range communication connection form of an electronic device according to an embodiment the disclosure.

Referring to FIG. 1, an electronic device 100 may be connected to an access point (AP) 140 based on multiple communication methods based on Wi-Fi. According to various embodiments, the electronic device 100 may include a processor 120 and a communication module 130.

According to various embodiments, the communication module 130 may receive communication signals from outside or transmit communication signals to outside based on a Wi-Fi communication method (e.g., IEEE 802.11be). For example, the communication module 130 may operate based on at least one of IEEE 802.11ac, 802.11ax, 802.11be, or 802.11bn among Wi-Fi communication methods, and in particular, IEEE 802.11be or 802.11bn has enhanced performance by supporting wider bandwidth, higher data throughput, and shorter latency compared to IEEE 802.11ax.

According to various embodiments, the communication module 130 may include a transceiver 131 for data transmission/reception with an external device and a communication processor 133 (e.g., communication processor (not shown) or short-range wireless communication module (e.g., Wi-Fi chipset)). According to various embodiments, the communication module 130 may further include memory.

According to various embodiments, the transceiver 131 may convert a baseband transmission signal into a radio signal or convert a received radio signal into a baseband reception signal.

According to various embodiments, the communication module 130 may further include components for orthogonal frequency division multiplexing (OFDM) or orthogonal frequency division multiple access (OFDMA), e.g., a modulator, a digital-analog (D/A) converter, a frequency converter, an A/D converter, an amplifier, and/or a demodulator, in addition to the transceiver 131 and the communication processor 133.

Although not shown, according to various embodiments, the electronic device 100 may include at least one antenna module that is electrically connected with the communication module of the access point 140 and supports the communication protocol and/or frequency band supported by the communication module of the access point 140.

According to various embodiments, the communication processor 133 may control the transceiver 131 to form a communication connection with the access point 140. For example, the communication connection may include a Wi-Fi network. For example, the communication processor 133 may control the transceiver 131 to form a wireless connection with the access point 140 using IEEE 802.11ac, 802.11ax, 802.11be, or 802.11bn system 2.4 GHz, 5 GHz or 6 GHz band wireless local area network (WLAN) standards. Or, the communication processor 133 may control the transceiver 131 to form a radio connection with the access point 140 using IEEE 802.11ad or 802.11ay 60 GHz band WLAN standards.

According to various embodiments, the scheme of performing communication using the wireless local area network (WLAN) standards between the electronic device 100 and the access point 140 may be referred to as a communication scheme based on STA mode.

According to various embodiments, the processor 120 may include an application processor. The processor 120 may perform a designated operation of the electronic device 100 or control another piece of hardware (e.g., the communication module 130) to perform a designated operation.

According to various embodiments, the access point 140 may support the operation of transmitting data to an external network and/or receiving data from the external network by a plurality of electronic devices (e.g., the electronic device 100) based on connection between the plurality of electronic devices (e.g., the electronic device 100) and the external network (e.g., Internet, external LAN, or cellular network).

According to various embodiments, the access point 140 may be a wireless router. The access point 140 may be a dedicated wireless router or a general-purpose device supporting mobile hotspot, but is not limited in implementation. For example, the access point 140 may include the same components (e.g., processor and/or communication module) as the electronic device 100.

According to various embodiments, the access point 140 may transmit/receive data to/from an external device, such as a server or the electronic device 100. For example, the access point 140 may transmit at least part of the data received from a server to the electronic device 100. According to various embodiments, the access point 140 and the electronic device 100 may transmit/receive uplink (UL)/downlink (DL) data during an operation period. For example, the access point 140 may transmit traffic to the electronic device 100 only during an operation period set based on the schedule information received from the electronic device 100.

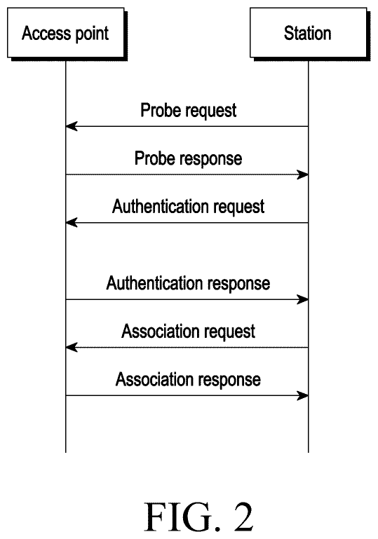

FIG. 2 is a view illustrating operations of an access point and a station for establishing Wi-Fi access according to an embodiment of the disclosure.

FIG. 2 illustrates that an access point may communicate with a station based on Wi-Fi as illustrated in FIG. 1. The station may be implemented as the electronic device 100 of FIG. 1. The station may be a terminal supporting Wi-Fi communication according to IEEE 802.11 standards (or a terminal with a Wi-Fi interface).

The station may transmit (or broadcast) a probe request frame to the access point. According to an embodiment, the probe request message may be a frame for the station to discover surrounding access points. According to an embodiment, the probe request frame may include information about at least one communication capability supported by the station. According to an embodiment, the station may receive a beacon frame from the access point and transmit a probe request frame to the access point based on information included in the beacon frame. The beacon frame is one of management frames in IEEE 802.11, and may be periodically transmitted to announce the presence of a wireless network and allow scanning STAs to discover and participate in the wireless network. The access point may transmit a probe response frame in response to the probe request frame.

Upon receiving the probe response frame, the station may transmit an authentication request frame to the access point. The access point may transmit an authentication response frame to the station in response to the authentication request frame, and the authentication procedure between the access point and the station may be completed. According to an embodiment, the authentication procedure of transmitting/receiving the authentication request frame and authentication response frame may be a process of selecting and authenticating the channel with the strongest reception strength among frames received during the channel discovery process. According to an embodiment, through the authentication procedure, the station and the access point may negotiate the encryption method for the authentication procedure.

When the authentication procedure is completed, the station may transmit an association request frame to the access point to perform connection establishment with the access point. According to an embodiment, the association request frame may include information about at least one capability (e.g., according to IEEE 802.11 standards) to be used for data communication between the station and the access point. The access point may generate an association ID (AID) for the station and transmit an association response frame to the station.

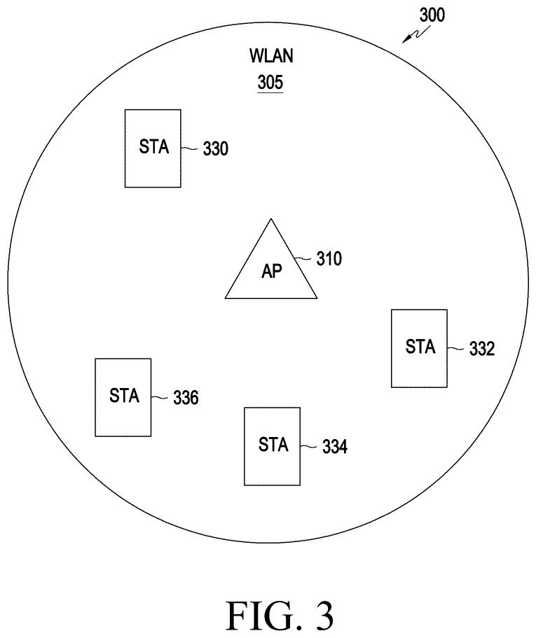

FIG. 3 is a view illustrating an example of a short-range communication connection form of an electronic device according to an embodiment of the disclosure.

Referring to FIG. 3, a wireless communication system 300 may include an access point 310, client electronic devices 330, 332, 334, 336 corresponding to stations, and a wireless local area network (WLAN) 305.

The wireless communication system 300 may be formed by an access point 310 that provides wireless communication channels or links to one or more stations (STAs) 330, 332, 334, 336.

The access point 310 is allocated a unique media access control (MAC) address. While the WLAN 305 illustrated in a circular shape in FIG. 3 is illustrated as an infrastructure basic service set (BSS) which is a basic building block in the IEEE 802.11 system, in other embodiments, the WLAN 305 may be an independent basic service set (IBSS) network, or a peer-to-peer (P2P) network (e.g., operating according to Wi-Fi Direct protocols). The circular shape of the WLAN 305 illustrated in FIG. 3 may also be understood as representing a coverage area where stations included in the corresponding BSS maintain communication. This area may be referred to as a Basic Service Area (BSA). When the stations 330, 332, 334, 336 move outside the BSA, they may not directly communicate with the access point or other stations within the corresponding BSA. The access point 310 may be a dedicated wireless router, or may be a station supporting mobile hotspot functionality, in which case the access point 310 may be referred to as an AP STA.

The stations 330, 332, 334, 336 are devices operating according to the Medium Access Control (MAC)/PHY specifications of IEEE 802.11. Unless the functionality of a station is separately distinguished from an access point, a station may include an AP STA and a non-AP STA. However, when communication is performed between an STA and an AP, the STA may be understood as a non-AP STA. When a station supports mobile hotspot functionality and operates like the access point 310, the station may be understood as an AP STA.

The stations 330, 332, 334, 336 may be any suitable Wi-Fi capable wireless device or electronic device including, e.g., cell phones, personal digital assistants (PDAs), tablet devices, laptop computers, etc. The stations 330, 332, 334, 336 may also be referred to as user equipment (UE), subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, the electronic device, or other suitable terminology.

As methods for performing data transmission of multiple wireless stations 330, 332, 334, 336 corresponding to UL clients connected to the access point 310 illustrated in FIG. 3, “point coordination function (PCF) transmission method” and “distributed coordination function (DCF) transmission method” may be used.

“Point coordination function (PCF) method transmission” refers to transmission in which the access point directly asks wireless stations about multiple wireless stations and makes data transmission wait.

“Distributed coordination function (DCF) method transmission” refers to transmission in which wireless stations sense and wait in advance to avoid collisions before transmitting data in an environment where multiple wireless stations compete to transmit data.

The DCF method transmission is a concept for providing services during contention periods and may handle waiting times by dividing traffic priorities into inter frame spaces (IFS) to request channel usage. In other words, priority may be determined by the size of the waiting time, and the shorter the time, the higher the priority packet waiting time may be. The IFS may include short IFS (SIFS), PCF IFS (PIFS), and DCF IFS (DIFS).

The SIFS has the highest priority with the shortest period and may be mainly used as waiting time for control information. The PIFS may have medium priority with a medium-length period. The DIFS is the longest time interval compared to SIFS and PIFS, has low priority, and is mainly used as waiting time for channel identifying. In other words, it listens (or waits) for channel usage during the DIFS period. If the channel is busy during the DIFS period, transmission may be delayed.

However, since this DCF method does not consider priority between STAs, there is a problem that it is difficult to support various types of data transmission and Quality of Service (QoS), so hybrid coordination function (HCF) was introduced. HCF is based on the DCF and point coordination function (PCF). PCF refers to a polling-based synchronous access method that periodically polls so that all receiving APs and/or STAs may receive data frames. HCF includes enhanced distributed channel access (EDCA), which is a contention-based channel access method, and HCF controlled channel access (HCCA), which is based on a contention free-based method using a polling mechanism. HCF also includes a media access mechanism to enhance QoS of WLAN and may transmit QoS data in both contention period (CP) and contention free period (CFP).

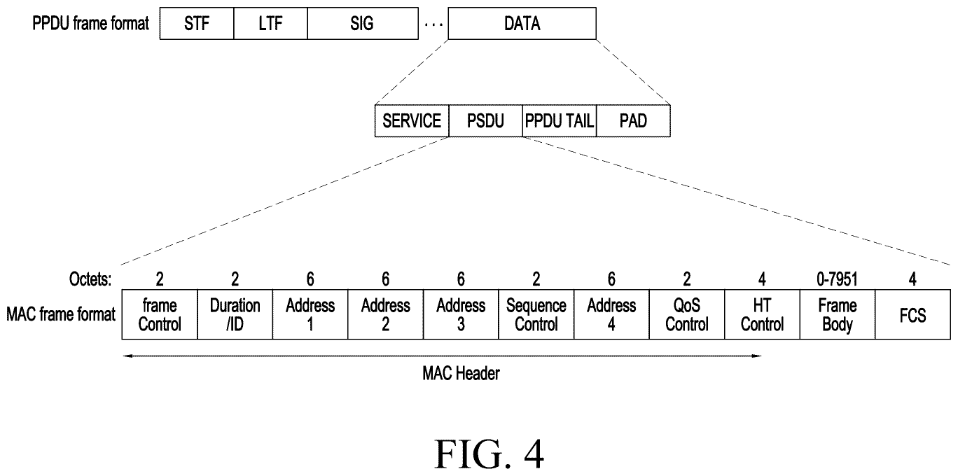

FIG. 4 is a view illustrating an example of a frame structure used in an IEEE 802.11 system according to an embodiment of the disclosure.

The physical layer protocol data unit (PPDU) format may be configured including at least one of a short training field (STF), a long training field (LTF), a SIGNAL (SIG) field, and a data field. The most basic (e.g., non-high throughput (HT)) PPDU frame format may be composed of only legacy-STF (L-STF), legacy-LTF (L-LTF), SIG field, and data field.

STF may be used for frame timing acquisition, automatic gain control (AGC), diversity detection, and coarse frequency/time synchronization. LTF may be used for fine frequency/time synchronization and channel estimation. STF and LTF together may be referred to as a PLCP preamble, and the PLCP preamble may be said to be a signal for synchronization and channel estimation of the OFDM physical layer.

The SIG field may be used to transmit control information for demodulation and decoding of the data field. The SIG field may include information about data rate and data length. Further, the SIG field may include parity bits, SIG TAIL bits, etc.

The data field may include a SERVICE field, physical layer service data unit (PSDU), PPDU TAIL bits, and may also include padding bits when necessary. Some bits of the SERVICE field may be used for a descrambler at the receiving end. The PSDU corresponds to a MAC protocol data unit (MPDU) defined in the MAC layer and may include data generated/used in higher layers. PPDU TAIL bits may be used to return the encoder to a 0 state. Padding bits may be used to adjust the length of the data field to a predetermined unit.

The MPDU is defined according to various MAC frame formats, and a basic MAC frame consists of a MAC header, a frame body, and a frame identify sequence (FCS). The MAC frame may be composed of MPDUs and transmitted/received through the PSDU of the data portion of the PPDU format.

The MAC header is defined as an area including a frame control field, a duration/ID field, an address 1 field, an address 2 field, an address 3 field, a sequence control field, an address 4 field, a QoS control field, and an HT control field.

The frame control field includes information about the characteristics of the corresponding MAC frame. The duration/identifier field may be implemented to have different values according to the type and subtype of the corresponding MAC frame.

The address 1 field to address 4 field are used to indicate BSSID, source address (SA), destination address (DA), transmitting address (TA) indicating the transmitting STA address, and receiving address (RA) indicating the receiving STA address.

The sequence control field is set to include a sequence number and a fragment number. The sequence number may indicate the sequence number allocated to the corresponding MAC frame. The fragment number may indicate the number of each fragment of the corresponding MAC frame.

The QoS control field includes QoS-related information. The QoS control field may be included when the Subtype subfield indicates a QoS data frame. The HT control field includes control information related to HT and/or VHT transmission/reception techniques.

The frame body is defined as a MAC payload, where data to be transmitted from higher layers is positioned, and has a variable size. For example, the maximum MPDU size may be 11454 octets, and the maximum PPDU size may be 5.484 ms.

FCS is defined as a MAC footer and is used for error detection of MAC frames.

The first three fields (frame control field, duration/identifier field, and address 1 field) and the last field (FCS field) constitute the minimum frame format and are present in all frames. Other fields may be present only in specific frame types.

The following describes the network allocation vector (NAV) used in wireless LAN networks.

The CSMA/CA mechanism includes virtual carrier sensing as well as physical carrier sensing where the AP and/or STA directly sense the medium. Virtual carrier sensing is intended to compensate for problems that may occur in media access, such as hidden node problems. For virtual carrier sensing, the MAC of the wireless LAN system may use NAV. NAV is a value that indicates to other APs and/or STAs the remaining time until the medium becomes available by an AP and/or STA that is currently using or has the right to use the medium. Therefore, the value set as NAV corresponds to the period during which medium use is scheduled by the AP and/or STA transmitting the corresponding frame, and STAs receiving the NAV value are prohibited from accessing the medium during that period. NAV may be set, e.g., according to the value of the duration field of the frame's MAC header.

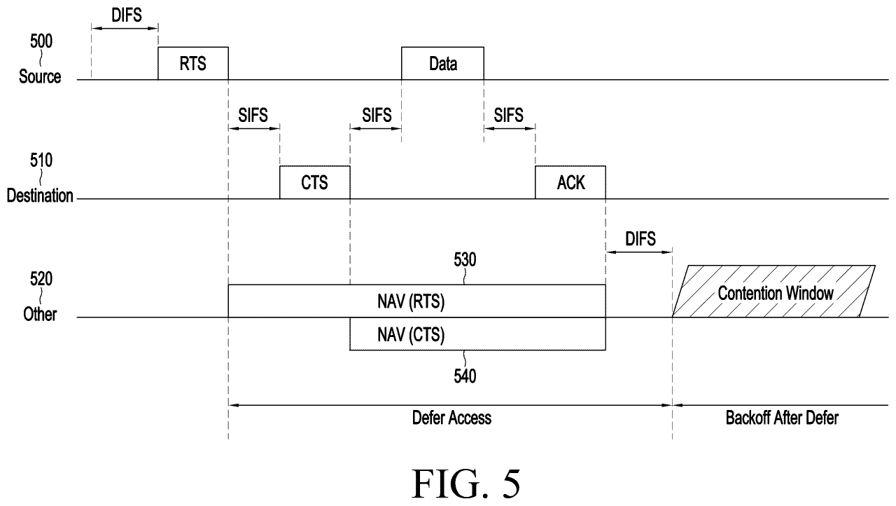

FIG. 5 is a view illustrating an example of network allocation vector (NAV) setting according to an embodiment of the disclosure.

Referring to FIG. 5, a source STA 500 transmits an RTS frame after DIFS, and a destination STA 510 transmits a CTS frame after SIFS. The destination STA 510 designated as a receiver through the RTS frame does not set NAV. Some of the remaining STAs 520 may receive the RTS frame and set NAV (530), and others may receive the CTS frame and set NAV (540).

If a CTS frame (e.g., PHY-RXSTART.indication primitive) is not received within a predetermined period from the time the RTS frame is received (e.g., the time when the MAC receives the PHY-RXEND.indication primitive corresponding to the RTS frame), STAs that set or updated NAV through the RTS frame may reset NAV (e.g., to 0). The predetermined period may be (2*aSIFSTime+CTS_Time+aRxPHYStartDelay+2*aSlotTime). CTS_Time may be calculated based on the length and data rate of the CTS frame indicated by the RTS frame. The predetermined period may be a NAVTimeout period.

While FIG. 5 illustrates setting or updating NAV through an RTS frame or CTS frame for convenience, NAV setting/resetting/updating may also be performed based on the duration field of other various frames, e.g., non-HT PPDU, HT PPDU, VHT PPDU, or HE PPDU (e.g., duration field in the MAC header of a MAC frame).

Further, basic NAV and intra-BSS NAV were introduced in 802.11ax. Basic NAV is always set (mandatory) by NAV from frames transmitted by APs or STAs other than itself, and intra-BSS NAV may be optionally set by NAV from frames transmitted in the BSS to which it belongs. An AP or STA may access the medium when both NAV timers have expired (or after both NAV time intervals have passed).

The following describes TXOP. Transmission opportunity (TXOP) was newly introduced in 802.11e MAC to guarantee QoS and increase channel utilization. To guarantee QoS, TXOP may be used to allocate opportunities for preferential transmission when two or more packets correspond to the same access category (AC).

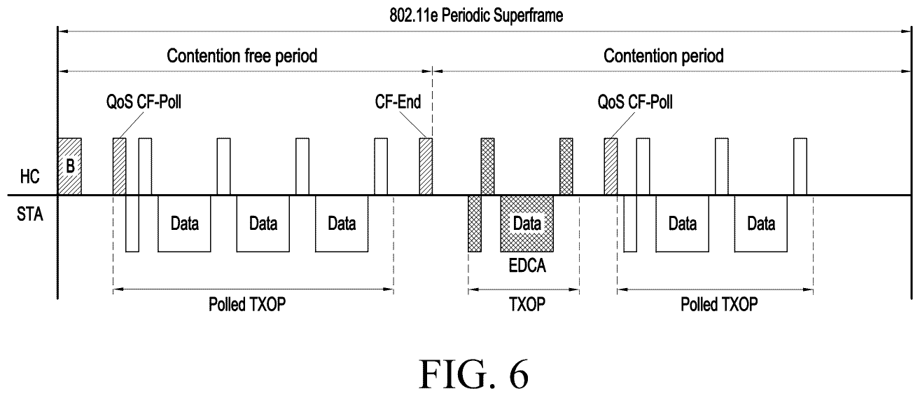

FIG. 6 is a view illustrating an example of transmission opportunity (TXOP) according to an embodiment of the disclosure.

An STA participating in QoS transmission may obtain a TXOP to transmit traffic for a predetermined period using two channel access methods: enhanced distributed channel access (EDCA) and HCF controlled channel access (HCCA). TXOP acquisition is possible by succeeding in EDCA contention or receiving a QoS CF-Poll (Contention-Free Poll) frame from an AP, with the former called EDCA TXOP and the latter called Polled TXOP. As such, using the concept of TXOP, a predetermined time may be given for any one STA to transmit frames or transmission time may be forcibly limited.

The transmission start time and maximum transmission time of TXOP are determined by the AP, which is notified to the STA by a beacon frame in the case of EDCA TXOP and by a QoS CF-Poll frame in the case of Polled TXOP.

NAV may be understood as a type of timer for protecting the TXOP of a transmitting STA (e.g., TXOP holder). An STA may protect another STA's TXOP by not performing channel access during the period when its set NAV is valid. In the current wireless LAN system, TXOP duration is set through the duration field of the MAC header. In other words, the TXOP holder and TXOP Responder (e.g., Rx STA) transmit the entire TXOP information necessary for frame transmission/reception in the duration field of frames they exchange. Third party STAs that are neither TXOP holders nor TXOP responders identify the Duration field of frames exchanged between the TXOP holder and TXOP responder, and postpone channel use until the NAV period by setting/updating NAV.

The following describes the 802.11be standard. 802.11be, also called extremely high throughput (EHT), operates in all 2.4, 5, and 6 GHz bands and is being developed to provide 320 MHz wide bandwidth, 4096QAM, multi resource unit (RU) and multi-link operation (MLO), providing speeds up to 46 Gbps, which is 4.8 times faster than Wi-Fi 6, and low latency and high network throughput. Specifically, 802.11be provides 320 MHz wide bandwidth in the 6 GHz band, may transmit data through MU-MIMO providing 16 spatial streams in uplink and downlink, and adopts 4096QAM to achieve high transmission efficiency. Further, it features increased spectrum efficiency by flexibly performing spectrum resource scheduling through multiple RUs, and the ability to simultaneously transmit/receive data in various frequency bands and channels through multi-link operation.

The following describes ultra-high reliability (UHR). UHR refers to technical objectives designed to provide ultra-high reliability in the IEEE 802.11 standard. UHR ensures stable wireless communication in delay-sensitive and reliability-critical applications such as industrial automation, telemedicine, and AR/VR. It solves the problem that existing Wi-Fi technology, despite providing high bandwidth, did not sufficiently meet reliability and low latency requirements. To this end, technologies such as multi-link operation (MLO) and dynamic subchannel operation (DSO) are utilized to minimize interference and maximize reliability. It also includes efficient retransmission mechanisms and QoS management functions to reduce data transmission failures. It features maintaining stable performance even in high-density network environments and extending the use of Wi-Fi in applications requiring ultra-low latency and ultra-high reliability.

The following describes overlapping basic service set (OBSS) or inter-BSS (basic service set). Existing wireless LAN networks experience significant performance degradation, such as transmission rate, as the number of users increases. This is because the wireless LAN system basically uses the CSMA/CA method corresponding to time-division access control, so when adjacent networks are detected, frequency resources in the same band are shared by the activity time of adjacent networks.

Currently, there are many cases where multiple APs operate in a specific area, and in this case, performance degradation of the wireless LAN network occurs due to coverage overlap between APs. This is because the AP of each BSS and STAs connected to the AP are affected by signals from adjacent BSSs, resulting in interference from adjacent BSSs and decreased transmission rates due to collisions between signals transmitted at the same time. A BSS that may affect signal transmission (or has overlapping coverage) in this way may be referred to as an overlapping BSS (OBSS) or inter-BSS (basic service set). The content described below for OBSS may be equally applied using the term inter-BSS. To solve this problem, interference avoidance technology that divides the bands available to each user so they do not overlap or performs channel switching to unused channels, and interference alignment technology that reduces the impact of interference even when using the same band, are being researched.

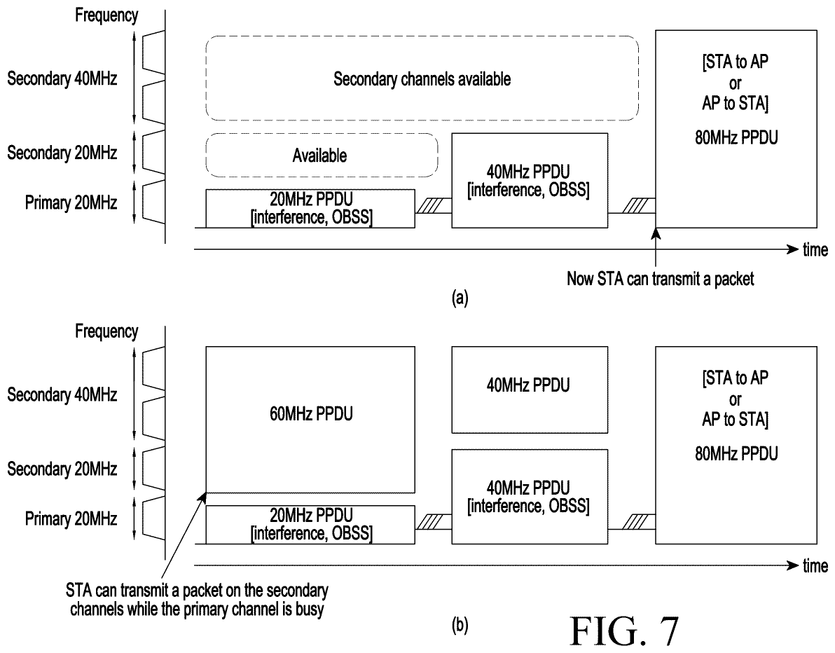

FIG. 7 is a view illustrating an example of non-primary channel access (NPCA) according to an embodiment of the disclosure.

FIG. 7 illustrates a wideband channel composed of a 20 MHz primary channel (primary 20 MHz channel) and multiple 20 MHz secondary channels (secondary 20 MHz channels). This is for convenience of description and the disclosure is not limited thereto.

The primary channel is a common channel operated by all STAs that are members of the BSS. For example, in a 20 MHz, 40 MHz, 80 MHz, 160 MHz, or 80+80 MHz BSS, the primary channel may be a primary 20 MHz channel.

The secondary channel is a channel associated with the primary channel and is used to create a channel wider than the primary channel. The secondary channel may be a channel included in the bandwidth excluding the primary 20 MHz channel from the BSS channel bandwidth. As another example, when the BSS channel bandwidth is 40 MHz, the secondary channel may be a 20 MHz channel excluding the primary 20 MHz channel from the BSS channel bandwidth. As another example, when the BSS channel is 80 MHz, the secondary channel may be the remaining 40 MHz channel excluding the 40 MHz including the primary 20 MHz from the BSS channel bandwidth.

According to current 802.11 standards, in any transmission (e.g., transmission on 20/40/80/160/320 MHz channels), the primary channel (primary 20 MHz channel) should be idle for access to a wideband channel greater than 20 MHz. Therefore, when the primary channel is busy, the AP/STA may not transmit on any idle secondary channel. In other words, if the primary channel is busy, transmission may not be performed on the secondary channel even when the secondary channel is idle.

For example, referring to part (a) of FIG. 7, even when the secondary channel is available, transmission may not be performed when the primary channel is busy.

For example, the primary channel may be busy due to interference from a 20 MHz PPDU corresponding to an overlapping BSS (OBSS) (or inter-BSS (basic service set)), and in this case, transmission may not be performed even when 60 MHz of secondary channels are available.

For example, the primary channel may be busy due to interference from a 40 MHz PPDU corresponding to an OBSS (or inter-BSS), and in this case, transmission may not be performed even when 40 MHz of secondary channels are available.

In other words, according to current IEEE 802.11 standards, an STA may transmit packets when the primary channel is idle. In other words, when the primary channel is idle, an STA may perform transmission using the primary channel and secondary channels (e.g., transmission of an 80 MHz PPDU). This applies equally to not only uplink (UL) transmission of STAs but also downlink (DL) transmission of APs.

Therefore, the current secondary channel access mechanism (or scheme) is inefficient for wideband channels (e.g., 160 MHz channel, 320 MHz channel) or large bandwidth, and a better secondary channel access mechanism (or scheme) is needed to fully utilize wideband channels.

Non-primary channel access (NPCA) is being discussed as a solution to the above-mentioned problems. NPCA may be triggered based on OBSS PPDU (or inter-BSS PPDU) and/or OBSS TXOP (or inter-BSS TXOP). According to NPCA, when the primary channel is busy and secondary channels are available, AP/STA may transmit on available secondary channels.

An NPCA primary channel may be defined among (or within) secondary channels. The NPCA primary channel may be a channel where channel access (e.g., EDCA) is performed while the primary channel is busy. In other words, the NPCA primary channel may be a channel where channel access is performed while the primary channel is busy within secondary channels. As an example, the NPCA primary channel may have a bandwidth of 20 MHz, but this is merely an example for description and does not limit the scope of the disclosure. The NPCA primary channel may be named an anchor channel, but the disclosure is not limited to this specific name.

For example, referring to part (b) of FIG. 7, when the primary channel is busy, transmission may be performed on available secondary channels.

For example, when the primary channel is busy due to interference from a 20 MHz PPDU corresponding to OBSS (or inter-BSS), an STA may transmit a packet (e.g., 60 MHz PPDU) on available secondary channels while the primary channel is busy. Channel access may be performed on the anchor channel within the secondary channels, and accordingly, packets may be transmitted on the secondary channels when the anchor channel is idle. This applies equally to not only UL transmission of STAs but also DL transmission of APs.

For example, when the primary channel is busy due to interference from a 40 MHz PPDU corresponding to OBSS (or inter-BSS), an STA may transmit a packet (e.g., 40 MHz PPDU) on available secondary channels while the primary channel is busy. Channel access may be performed on the anchor channel within the secondary channels, and accordingly, packets may be transmitted on the secondary channels when the anchor channel is idle. This applies equally to not only UL transmission of STAs but also DL transmission of APs.

In the description of an embodiment, an NPCA AP may mean an AP capable of performing NPCA (or an AP that performs/can perform operations related to NPCA), and an NPCA STA may mean an STA associated with an NPCA AP and capable of performing NPCA (or an STA that performs/can perform operations related to NPCA). Unless otherwise specifically stated, AP, NPCA AP, STA, and NPCA STA may be used interchangeably in the disclosure. In particular, the NPCA AP and NPCA STA used for the following description mean an AP and/or STA capable of performing NPCA, and their meaning is not limited to an AP and/or STA performing NPCA at the time of description. In other words, the NPCA AP may be an STA supporting mobile access point functionality, and in this case, the NPCA AP may be referred to as an NPCA STA. In other words, the NPCA STA may include a non-AP STA and an AP capable of performing NPCA.

When the AP or STA within an OBSS (or inter-BSS) initiates an OBSS TXOP (or inter-BSS TXOP), the NPCA AP and/or NPCA STA within the BSS may set BasicNAV (Basic NAV, NAV) and perform NPCA. For example, BasicNAV may be set for the primary channel.

For example, when identifying that the AP or STA within an OBSS (or inter-BSS) has initiated an OBSS TXOP (or inter-BSS TXOP) according to RTS-CTS exchange, the NPCA AP and/or NPCA STA within the BSS may set BasicNAV and perform NPCA.

Here, whether to perform NPCA may be identified based on a comparison between the OBSS TXOP (or inter-BSS TXOP) and a specific duration threshold. For example, when the OBSS TXOP (or inter-BSS TXOP) is shorter than (or less than or equal to) a specific duration threshold, NPCA may not be performed. Conversely, when the OBSS TXOP (or inter-BSS TXOP) is longer than (or greater than or equal to) a specific duration threshold, NPCA may be performed. This considers that when the OBSS TXOP (or inter-BSS TXOP) is relatively short, it may be advantageous to wait until the end of the OBSS TXOP (or inter-BSS TXOP) rather than performing NPCA-based operations.

Secondary channels where NPCA will operate and an anchor channel (e.g., 20 MHz anchor channel) where channel access (e.g., EDCA) procedures is performed within the secondary channels may be pre-configured and/or pre-agreed between the NPCA AP and/or NPCA STAs within the BSS. Secondary channels where NPCA operates may be named non-primary channels (NPCHs), but the disclosure is not limited to this specific name.

The operation of the NPCA AP may be as follows.

The NPCA AP may not perform NPCA in bands outside the operating bandwidth. In other words, the NPCA AP may perform NPCA within the operating bandwidth.

The NPCA AP may perform NPCA if the secondary channel is idle during a PIFS interval immediately preceding the starting point of an OBSS TXOP (or inter-BSS TXOP).

When the NPCA AP has a separate NAV timer, i.e., when a separate NPCH NAV timer for the anchor channel is set, if the NPCH NAV timer has a non-zero value, the NPCA AP may not be able to initiate a TXOP within the NPCH. When the NPCA AP has a separate NAV timer, i.e., when a separate NPCH NAV timer for the anchor channel is set, if the NPCH NAV timer is 0, the NPCA AP may initiate a TXOP within the NPCH.

The NPCA AP may perform channel access (e.g., EDCA contention) on the anchor channel where OBSS (or inter-BSS) transmission does not overlap, and the remaining channels within the NPCH (excluding the anchor channel) may be accessed by energy detection (ED). For example, if PIFS is idle just before the end of the backoff counter of the anchor channel, the remaining channels may be accessed.

The operation of the NPCA STA may be as follows.

The NPCA STA may switch operating bandwidth to perform NPCA. Unlike the NPCA AP that does not perform NPCA in bands outside the operating bandwidth, the NPCA STA may change the operating bandwidth to perform NPCA. For example, the NPCA STA may perform NPCA by changing to an operating bandwidth according to the AP's instruction/configuration and/or a predefined/promised operating bandwidth.

The NPCA capability of an STA and/or the on/off state of NPCA capability may be set through prior information and/or message exchange. The STA and the AP may identify whether NPCA may be performed, i.e., NPCA capability, by exchanging Probe request and Probe response or Association request and Association response. Subsequently, the AP and STA capable of performing NPCA may exchange visible (detected) surrounding OBSS information (e.g., MAC address or color information of OBSS APs and STAs) to establish an OBSS list that is not in a hidden relationship with each other, and may perform NPCA when transmission from the corresponding OBSS occurs.

When performing NPCA, the anchor channel for performing EDCA and the NPCH that may transmit data including the anchor channel may be predetermined through information exchange between the NPCA AP and NPCA STA. NPCA is a representative communication method for high-speed data transmission (e.g., ultra-high reliability (UHR)) to enhance resource use efficiency discussed in IEEE 802.11 specifications.

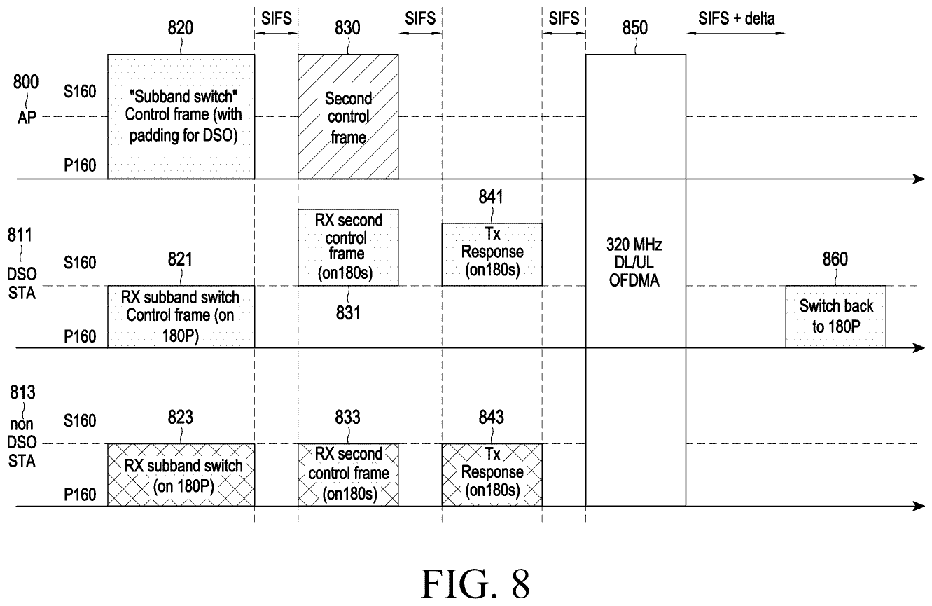

FIG. 8 is a view illustrating an example of dynamic subchannel operation (DSO) according to an embodiment of the disclosure.

The AP 800, DSO STA 811, and non-DSO STA 813 illustrated in FIG. 8 may be interconnected and communicate like the AP, the electronic device, and station described with reference to FIGS. 1 and 2. The DSO STA 811 and non-DSO STA 813 illustrated in FIG. 8 may be STAs included in the BSS of the AP 800 as described with reference to FIG. 3.

The DSO STA 811 refers to an STA supporting DSO functionality (and/or broadband wireless access (BWA) functionality), and the non-DSO STA 813 may refer to an STA not supporting DSO functionality (and/or BWA functionality).

FIG. 8 illustrates, e.g., a case where the AP 800 provides 320 MHz bandwidth and the STAs 811, 813 use 160 MHz bandwidth as operating channel bandwidth.

More specifically, an STA operating on a link with an AP where the STA operating bandwidth is narrower than the AP bandwidth of that link may be configured to switch operating channel bandwidth between primary and secondary channels of the access point operating bandwidth.

For example, as illustrated in FIG. 8, the 320 MHz operating bandwidth of the AP 800 may be divided into a 160 MHz primary (P160) subchannel and a 160 MHz secondary (S160) subchannel. While FIG. 8 describes division into 160 MHz subchannels, the description of the disclosure may also be applied to subchannels of other bandwidths. For example, a 160 MHz operating channel may be divided into 4×40 MHz subchannels, where the first subchannel is the primary channel and the other subchannels may be referred to as secondary channels.

In an embodiment, the width of a subchannel may be 20 MHz, 40 MHz, 80 MHz, or 160 MHz, and the operating bandwidth may be 40 MHz, 80 MHz, 160 MHz, or 320 MHz. In any of the embodiments described in the disclosure, a subchannel may include a broadband wireless access subchannel.

In an embodiment, the AP may create a (BWA) TXOP including frame exchange between a non-DSO STA operating on a secondary subchannel of a specific bandwidth and/or some other STAs operating on a primary subchannel of a specific bandwidth.

The AP may dynamically allocate various portions of subchannels within the operating bandwidth to non-AP STAs according to at least one of operating bandwidth functionality, channel conditions, and QoS requirements within the TXOP. The AP may start transmitting to the DSO STA after sufficient delay to allow channel switching. When the TXOP ends, the DSO STA may switch back to the default channel (e.g., primary channel). To describe this in more detail:

Referring to FIG. 8, the AP 800 may transmit a “subband switch” control frame 820 on the P160 subchannel and S160 subchannel. The subband switch control frame may include a trigger frame. The subband switch control frame may be transmitted over the entire 320 MHz bandwidth. The subband switch control frame may include information instructing DSO STAs within the BSS about RU allocation for them at S160. The subband switch control frame 820 may explicitly indicate which DSO STAs among the DSO STAs within the BSS will switch to S160. However, the indication of DSO STAs to switch channels in the subband switch control frame 820 is not mandatory, and DSO STAs included in the BSS of the AP 800 may voluntarily switch operating bandwidth to the secondary channel based on the subband switch control frame 820.

The subband switch control frame 820 may include sufficient padding to cover the subband (subchannel) switch latency indicated during association. The subband switching latency depends on the implementation of the non-AP STA and may be negotiated during DSO capability signaling. A DSO TXOP may be initiated due to the subband switch control frame.

The DSO STA 811, while operating on P160 of at least one link, may receive the subband switch control frame when the DSO TXOP starts (821). The non-DSO STA 813, while operating on P160 of at least one link, may receive the subband switch control frame when the DSO TXOP starts (823). After receiving the subband switch control frame 820 that marks the start of the DSO TXOP, the DSO STA 811 may switch operating channel bandwidth from the P160 subchannel to the S160 subchannel. For example, after receiving the subband switch control frame that marks the start of the DSO TXOP (step 820), the DSO STA 811 may voluntarily switch operating bandwidth from the P160 subchannel to the S160 subchannel based on resource allocation information included in the subband switch control frame.

Subsequently, the AP 800 may transmit a second control frame 830 on the P160 subchannel and S160 subchannel after SIFS following transmission of the subband switch control frame 820. Accordingly, when the DSO STA 811 has switched operating band from the P160 subchannel to the S160 subchannel, it may receive the second control frame on the S160 subchannel (831). The non-DSO STA 813 may receive the second control frame on the S160 subchannel (833).

The second control frame 830 may request the DSO STA 811 and non-DSO STA 813 to transmit responses on the subchannel where they will continue communication during the DSO TXOP. In other words, the second control frame 830 may be used by the AP 800 to identify whether STAs within the BSS have performed DSO and switched subchannels. Accordingly, the DSO STA 811 may transmit a response frame 841 to the second control frame 830 on the S160 subchannel. The non-DSO STA 813 may transmit a response frame 843 to the second control frame 830 on the S160 subchannel. Thus, during the DSO TXOP, the DSO STA 811 may remain on the S160 subchannel, and the non-DSO STA 813 may remain on the P160 subchannel.

Subsequently, after SIFS following transmission of the response frames 841, 843 by the DSO STA 811 and non-DSO STA 813, the AP 800, DSO STA 811, and/or non-DSO STA 813 may perform DL/UL OFDMA communication in the 320 MHz bandwidth during the DSO TXOP (850). The DSO STA 811 may switch back to the P160 subchannel at the end of the DSO TXOP, i.e., after SIFS+delta following DL/UL OFDMA communication in the 320 MHz bandwidth (860).

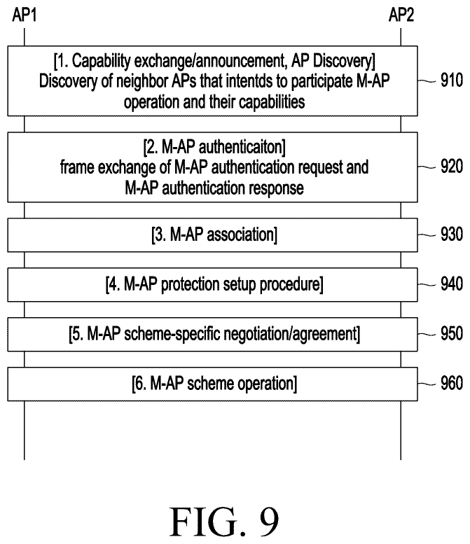

FIG. 9 is a view illustrating an example of a configuration of a Multi-AP (access point) Coordination framework of a wireless LAN system according to an embodiment of the disclosure.

The disclosure describes methods for identifying whether APs support Multi-AP operations and securing reliability prior to association or connection for performing Multi-AP operations between multiple APs. More specifically, to perform coordination operations between APs according to a Multi-AP coordination scheme (hereinafter referred to as M-AP scheme) (e.g., coordinated time division multiple access (C-TDMA), coordinated restricted target wake time (C-R-TWT), coordinated spatial reuse (C-SR), or coordinated beamforming (C-BF)), capability information (e.g., Multi-AP capability) needs to be shared between APs. Further, authentication may be needed to determine whether they may be combined into one pair or group to perform Multi-AP operations by indicating whether security is required. In this case, coordination operations between APs may also include functions such as Coordinated Operating mode negotiation and Coordinated Power saving scheduling, where APs cooperate to negotiate operating modes or power saving mode scheduling. Further, as in the examples, coordination operations between APs may be referred to as Multi-AP (M-AP or MAP, hereinafter referred to as M-AP), Coordinated-AP (C-AP), or Multi-AP Coordination (MAPC, or MAP-C), and may refer to operations or processes for communication between APs for smooth M-AP operation. Hereinafter, in the disclosure, the above-mentioned coordination operations between APs may be representatively referred to as M-AP, but the disclosure is not limited thereto designation.

Further, the M-AP operations described in the disclosure may be performed in one AP pair or an AP group including multiple APs. Therefore, in the embodiments described below, at least two or more APs performing M-AP operations may constitute one AP pair or one AP group. However, for convenience of description, the disclosure includes examples where one AP pair composed of two APs performs M-AP procedures.

Referring to FIG. 9, in 802.11bn, procedures for APs to share or advertise (hereinafter referred to as advertisement) their M-AP capabilities and negotiate or agree on which M-AP scheme to use may be defined as a general M-AP framework.

More specifically, in operation 910, for M-AP capability advertisement, information about each AP's M-AP capabilities may be broadcast or announced through management frames. Further, the management frame for M-AP capability advertisement may be referred to as an M-AP capability advertisement frame. Therefore, M-AP capabilities may be shared or exchanged between at least two or more APs (hereinafter, AP1 and AP2) in an unencrypted state. Further, a specific AP's broadcast M-AP capabilities may be discovered by at least one other AP. For example, at least one surrounding AP may overhear information from an AP broadcasting M-AP capabilities, which may be referred to as M-AP discovery passive scanning (e.g., the passive scanning method of FIG. 3 described above). Therefore, M-AP-related information between APs may be identified through M-AP capability advertisement. For example, the AP may identify information about whether at least one other AP supports M-AP or M-AP operation status. In an embodiment, the AP may identify at least one other AP that will participate in or may support M-AP operations. In an embodiment, APs participating in M-AP operations may also identify which M-AP operations (e.g., M-AP scheme) to perform based on information about discovered M-AP capabilities. Of course, the M-AP scheme may also be determined in steps after step 910 (e.g., initial control frame (ICF)/initial control response (ICR) exchange operations at the transmission opportunity (TXOP) level).

In operation 920, based on M-AP capabilities exchanged between APs, the APs may perform authentication. The authentication operation of 920 may include an authentication procedure to determine whether M-AP operations may be performed between APs. The authentication operation of 920 may be one of the IEEE 802.11 authentication methods (e.g., Fast BSS Transition (FT) authentication, Simultaneous Authentication of Equals (SAE), FILS authentication, Pre-association Security Negotiation (PASN) authentication, or Wi-Fi Protected Access 3 (WP3) based authentication). When the authentication operation of 920 is FT authentication, SAE, FILS authentication, PASN authentication, or WP3-based authentication as exemplified above, an authentication procedure to determine whether M-AP operations may be performed between APs may be performed by being included in portion of the detailed messages of the above-mentioned authentication operations.

The AP may enhance security through authentication operations to perform M-AP operations with an authenticated OBSS (or inter-BSS) AP (e.g., an AP of another BSS overlapping its own basic service set (BSS)). However, operation 920 may not be a mandatory step and may be selectively performed according to security-related needs. For example, if authentication between APs has been completed prior to the operations of the disclosure, operation 920 may be omitted. As another example, operation 920 may be performed as a separate operation before operation 950 below or may be performed in combination with operation 950.

In operation 930, based on operations 910 and 920, association or connection between APs (hereinafter referred to as M-AP association) may be performed. For example, APs that have detected and mutually discovered M-AP capabilities through operation 910 may allocate M-AP AIDs (e.g., AIDs between APs) for each AP for association. Meanwhile, hereinafter, the M-AP AID allocated for mutual identification between APs may also be referred to as AID, but as described above, it may of course refer to a different meaning from the AID allocated between an AP and a non-AP STA. Further, by exchanging the allocated AIDs between APs, the APs may identify each other's AIDs. In an embodiment, an AID may be allocated for each AP. In another embodiment, in addition to the M-AP AID, an ID for referring to an AP pair or AP group may be additionally allocated, which may be referred to as an M-AP Group ID (or M-AP GID).

In operation 940, APs may generate and negotiate security keys to support trigger frames based on WPS or MAC header protection. In this case, signaling may be possible by borrowing security procedures defined in IEEE 802.11 (e.g., Wi-Fi Protection Setup between APs or robust security network association (RSNA)).

In operation 950, APs may perform negotiation and agreement of M-AP functions or features. Even when referred to as a negotiation procedure or agreement procedure in the disclosure, it may mean a procedure including both the negotiation and agreement operations of operation 950. Further, M-AP features may mean features or functions that are distinguished according to M-AP schemes, or distinguished according to logical sessions (hereinafter referred to as sessions) created when different sessions are created through negotiation/agreement between APs even for the same M-AP scheme.

In operation 960, APs may perform operations corresponding to M-AP scheme(s) agreed upon between APs through operations 910 to 950 described above.

The names of each operation in FIG. 9 described above are merely examples for describing the operations of the corresponding operations and are not limited to the exemplified names. Therefore, each operation may be replaced with appropriate terms for describing the corresponding operation. For example, the M-AP association of operation 930 described above may also be referred to as M-AP link establishment, M-AP pre-negotiation, M-AP pre-configuration, or M-AP ID allocation.

Further, while the description of FIG. 9 describes M-AP operations performed between two APs, it may be similarly applied when performed between three or more APs (e.g., one AP group).

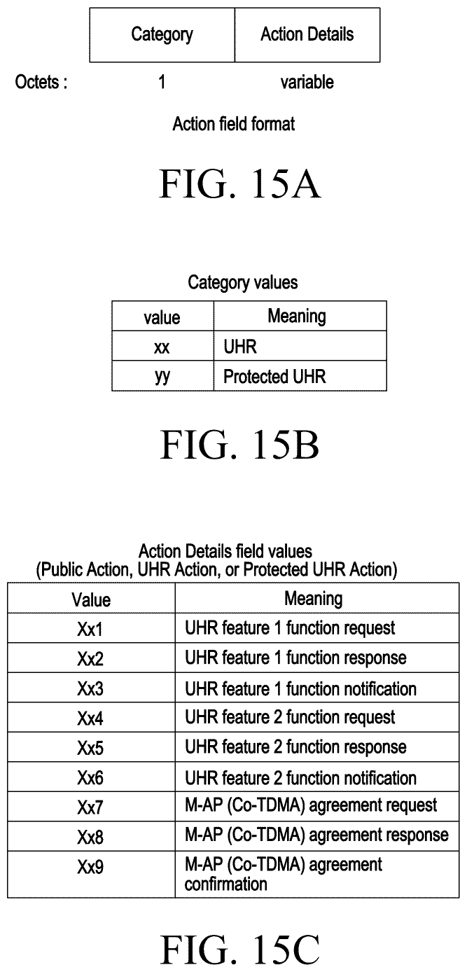

The frame used for each operation between two APs in FIG. 9 may be one of the Public Action frame, Protected dual of Public Action frame, UHR Action frame, or Protected UHR Action frame described with reference to FIGS. 15A, 15B, and 15C.

The UHR Action frame or Protected Action frame may be an Action frame newly defined to support UHR features defined in IEEE 802.11bn.

The Protected dual of Public Action frame is a frame used for robust STA-STA communication and may convey the same information as included in a Public Action frame. The field values following the category field in a Protected dual of Public Action frame may vary according to the Public Action field value in the Protected dual of Public Action frame, which is similar to the Public Action frame format.

The frame's purpose may be distinguished according to the value of the Public Action field included in a Public Action or Protected Public Action frame. According to the disclosure, Public Action fields for MAPC Request/Response may be defined as illustrated in Table 1 below, and MAPC Request/Response may be referred to as Co-TDMA agreement request/response.

TABLE 1

| Public Action field value | Description |
|---|---|
| Xx1 | MAPC Request (e.g., Co-TDMA |
| | agreement Request_{—} |
| Xx2 | MAPC Response (e.g., Co-TDMA |
| | agreement Response) |

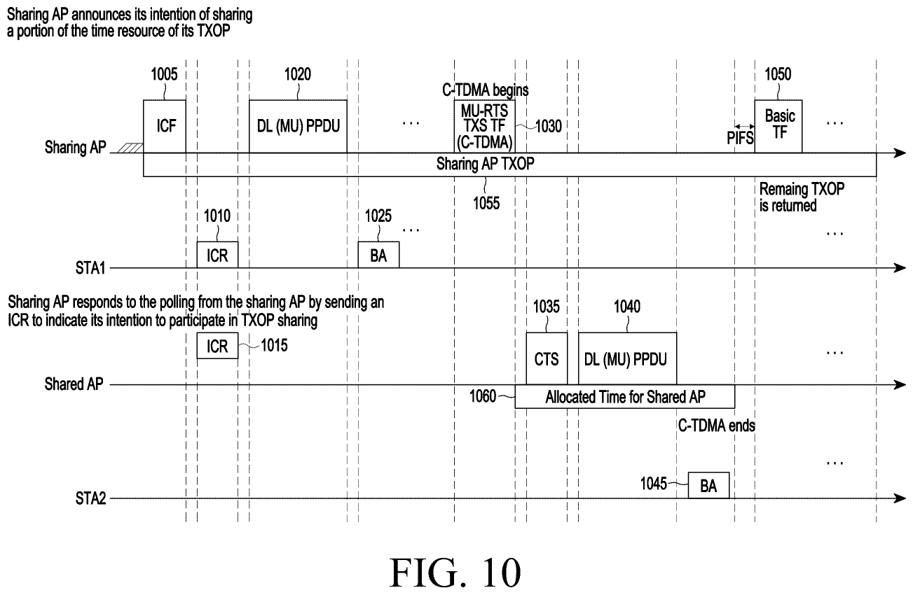

FIG. 10 is a view illustrating an example of an operation of Co-TDMA of a wireless LAN system according to an embodiment of the disclosure.

As discussions on the 802.11bn standard progress, various proposals for enhancing Co-TDMA are being discussed together. Co-TDMA refers to a procedure for a specific AP to share time resources of its obtained TXOP with a set of other APs, and may also be called TXS (TXOP sharing) in that a specific AP shares TXOP with another AP.

In Co-TDMA or TXS, an AP that shares (or transfers) its obtained TXOP to another AP may be referred to as a sharing AP. The sharing AP announces its intention to share at least a portion of the time resources of its obtained TXOP, and this process may be accomplished by transmitting an initial control frame (ICF) at the start of the TXOP (1005).

The ICF transmitted by the sharing AP may be a frame for polling the interest of target APs with which the sharing AP will share TXOP, and an AP that receives (or obtains) a portion of the TXOP obtained by the sharing AP in this way may be referred to as a shared AP or polled AP. The names sharing AP, shared AP, and polled AP are merely names for APs participating in Co-TDMA and TXS, and may be referred to by other names instead of the mentioned names.

The ICF 1005 transmitted by the sharing AP may include a duration field, and the duration field of the ICF 1005 may be set to a value representing the time length for transmitting an initial control response (ICR) in response to the ICF 1005 plus SIFS.

The ICF 1005 transmitted by the sharing AP may be delivered to STA1, which is an associated STA of the sharing AP, and a shared AP adjacent to the sharing AP, and STA1 receiving the ICF 1005 may transmit an initial control response (ICR) to respond to the ICF to the sharing AP (1010). The shared AP receiving the ICF 1005 from the sharing AP may also transmit an ICR 1015 to respond to the ICF 1005 to the sharing AP.

The sharing AP transmits a DL PPDU or DL multi user (MU) PPDU to STA1 within its TXOP 1055 (1020), and STA1 may transmit a block ack (BA) to the sharing AP in response to receiving the DL PPDU (1025).

Meanwhile, as the sharing AP determines to share at least a portion of its TXOP with the shared AP, the sharing AP may transmit an MU-RTS TXS trigger frame (TF) to the shared AP to announce the start (or initiation) of such TXS (or C-TDMA) (1030).

While FIG. 10 illustrates an embodiment where the sharing AP transmits the MU-RTS TXS TF to one shared AP, the sharing AP may also transmit the MU-RTS TXS TF to one or more shared APs (i.e., a set of APs).

The shared AP receiving the MU-RTS TXS TF may transmit a CTS frame to the sharing AP to indicate that it has identified the start (or initiation) of TXS (or C-TDMA) (1035), and may transmit a DL (MU) PPDU to STA2, which is a non-AP STA associated with it, within the time resource 1060 allocated to it (1040).

Meanwhile, the time resource 1060 allocated to the shared AP may be indicated by the allocation duration field of the MU-RTS TXS TF 1030 described above. STA2 may transmit a BA to the shared AP in response to the received DL (MU) PPDU (1045). The sharing AP, while monitoring the TXOP and identifying that there is no data transmission during PIFS, may reclaim the TXOP that was shared with the shared AP, and accordingly may transmit a basic TF within its TXOP 1055 to perform separate transmission/reception procedures (1050).

The TXS described with reference to FIG. 10 may be distinguished from existing procedures for sharing TXOP between an AP and a non-AP STA in that it shares TXOP between APs.

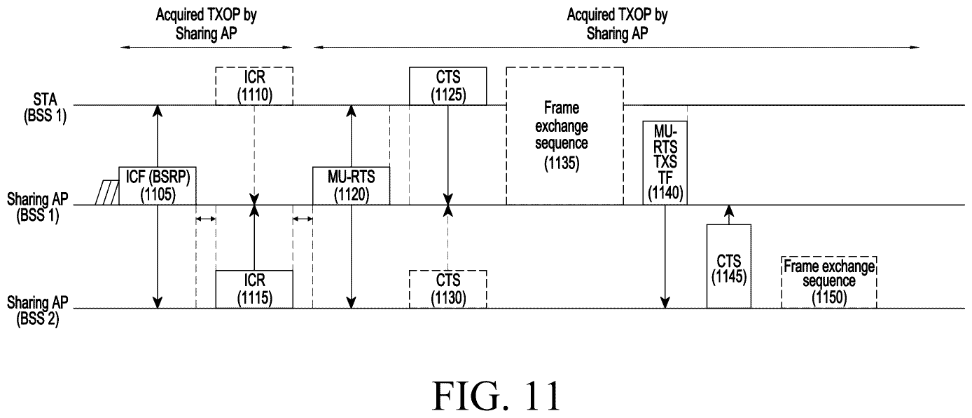

FIG. 11 is a view illustrating an example of Co-TDMA or triggered TXOP sharing (TXS) operation according to an embodiment of the disclosure.

FIG. 11 illustrates a sharing AP (related to BSS1) transmitting an ICF for polling Co-TDMA (or TXS) to a non-AP STA (related to BSS1) associated with it and a shared AP (related to BSS2) (1105), and this ICF may be to announce the sharing AP's intention to share a portion of the time resources of its TXOP with the shared AP and/or STA, and the ICF may include a buffer status report poll (BSRP) trigger frame.

Subsequently, the non-AP STA and shared AP receiving the ICF may transmit an ICR to the sharing AP (1110, 1115) to indicate whether the non-AP STA and shared AP will each participate in Co-TDMA (or TXS), and the ICR may include a multi STA block ACK frame.

Meanwhile, the time interval indicated by the duration field of the ICF transmitted by the sharing AP may equal the sum of SIFS and the frame length for ICR transmission. In this case, after ICF/ICR exchange, the sharing AP may transmit an MU-RTS (1120) frame after receiving the ICR (1115) and SIFS time to occupy a time interval including a time interval for frame exchange (1135) for communication with an STA within its BSS (BSS1) and a time interval to transfer to the shared AP.

The sharing AP transmitting MU-RTS (1120) and an STA within BSS1 sending CTS (1125) may indicate that frame exchange (1135) within BSS1 follows, and optionally, the shared AP sending CTS (1130) may additionally set NAV for STAs within the shared AP's BSS2 to protect the sharing AP's frame exchange (1135).

After the sharing AP's frame exchange (1135) within its BSS ends, it transmits an MU-RTS TXS TF (1140) to the shared AP to announce the start (or initiation) of TXS (or C-TDMA) within the TXOP, and the shared AP may transmit a CTS frame (1145) to the sharing AP in response.

Through the MU-RTS TXS TF (1140), the sharing AP may specify the time interval during which TXS (or C-TDMA) is performed within the TXOP, and subsequently the shared AP may perform frame exchange according to TXS (or C-TDMA) (1150).

According to the above-described embodiment, the sharing AP may separately transmit a frame for delivering TXOP scheduling information for TXS (or C-TDMA) to be performed (i.e., MU-RTS trigger frame) and a frame for announcing that TXS (or C-TDMA) actually starts (or initiates) (MU-RTS TXS TF). According to the proposed embodiment, by the sharing AP transmitting an MU-RTS trigger frame and the shared AP receiving it transmitting a CTS frame for response, the sharing AP may not only transmit TXOP scheduling information for TXS (or C-TDMA) but also solve the hidden node problem between the sharing AP and shared AP.

Meanwhile, according to another embodiment, to solve the over-protection problem, the shared AP receiving the MU-RTS trigger frame from the sharing AP may not transmit a response frame such as CTS.

In FIG. 11, the time interval for sending ICF (1105) and ICR (1110) and MU-RTS (1120), CTS (1125), frame exchange (1135), MU-RTS TXS TF (1140), CTS (1145), frame exchange (1150) may constitute one TXOP. In this case, the interval indicated by the duration field in ICF (1105) may be the sum of SIFS and the frame length for ICF transmission, but the TXOP length may be extended according to the duration field of frames transmitted in the following MU-RTS (1120) and frame exchange (1135).

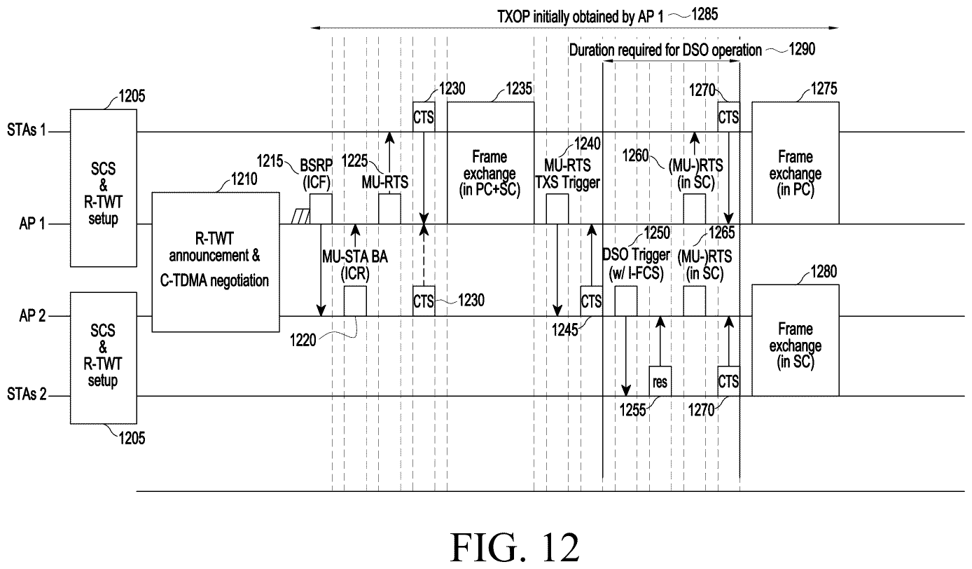

FIG. 12 is a view illustrating an example of TXS operation with DSO proposed in an embodiment according to the disclosure.

FIG. 12 describes an embodiment where a sharing AP shares (or transfers) a secondary channel (SCH) to a shared AP within a TXOP, and the shared AP performs DSO to exchange frames on the SCH within the TXOP. In this embodiment, the sharing AP may exchange frames on the primary channel (PCH) within the TXOP.

FIG. 12 describes an embodiment where AP1 (sharing AP) occupies and operates on the PCH within the TXOP while sharing the SCH with AP2 (shared AP). In the embodiment of FIG. 12, AP2 (shared AP) may perform DSO and exchange frames on the SCH as the SCH is shared within the TXOP.

AP1 may set up SCS and R-TWT with STA1 associated with it for QoS guarantee, and AP2 may also set up SCS and R-TWT with STA2 associated with it for QoS guarantee (1205). AP1 and AP2 each may announce their set up R-TWT and negotiate parameters or information for Co-TDMA (or TXS) with each other (1210).

More specifically, in operation 1210, one AP among AP1 and AP2 may request periodic Co-TDMA operation from the other AP for SCS traffic set up for QoS guarantee with STA1 associated with it and traffic to be processed within R-TWT SP. In this case, the AP requesting periodic Co-TDMA operation may request periodic Co-TDMA operation including information about what time period to request Co-TDMA and frequency and time resource information needed for processing its traffic within one Co-TDMA operation.

The AP receiving the periodic Co-TDMA request may respond with request results such as approval/rejection/other parameter proposals, and may additionally include valid channel access parameter (e.g., EDCA parameter) information within Co-TDMA operation to manage channel access of the two APs and STAs associated with the APs within Co-TDMA operation.

AP1 may obtain a TXOP for traffic processing. While the TXOP 1285 obtained by AP1 in FIG. 12 is illustrated as one time interval, the operations illustrated in FIG. 12 may also be performed across multiple TXOPs. AP1 transmits an ICF to AP2 to announce that the TXOP has started, and this ICF may include, e.g., a BSRP trigger frame (1215). The ICF may include information or parameters for announcing the intention of the sharing AP (AP1 in the illustrated example) for TXS (or C-TDMA).

AP2 receiving the ICF transmits an ICR to AP1, and this ICR may include, e.g., a multi-station (MU-STA) block ack (BA) frame (1220).

AP1 transmits an MU-RTS trigger frame to STA1 and AP2 for traffic processing within the TXOP (1225), and STA1 and AP2 may transmit CTS frames to AP1 in response (1230). According to an embodiment, the CTS response (1230) from AP2 may be optionally performed. The MU-RTS trigger frame may include information for additionally occupying or scheduling the time interval of the TXOP where TXS is performed.

As AP1 receives CTS (1230) in response to the MU-RTS trigger frame (1225), it may exchange frames with STA1 on PCH (i.e., PC) and SCH (i.e., SC) within the TXOP (1235). Meanwhile, the TXOP where the MU-RTS trigger frame and response are transmitted/received and frame exchange occurs may be the same TXOP where the ICF was transmitted earlier, or may be a separate different TXOP.

Subsequently, AP1 (i.e., sharing AP) transmits an MU-RTS TXS trigger frame to AP2 (shared AP) to indicate that TXOP sharing (i.e., TXS or Co-TDMA) has started (1240), and AP2 may transmit a CTS frame to AP1 in response to the MU-RTS TXS trigger frame (1245). TXOP sharing (i.e., TXS or C-TDMA) may start from the end of the CTS frame that AP2 transmits to AP1.

In an embodiment, when AP1 (i.e., sharing AP) shares (or transfers) SCH to AP2 (i.e., shared AP) within the TXOP, AP2 may exchange frames on the SCH within the TXOP. For AP2 to exchange frames on the SCH, AP2 may perform DSO with STA2 associated with it. To perform DSO, AP2 transmits a DSO trigger frame to STA2 (1250), and the DSO trigger frame may include I-FCS (and padding bits) considering the time required for STA2's band change.

STA2 receiving the DSO trigger frame transmits a response frame to AP2 on the SCH (1255), and the time interval 1290 required for the DSO procedure may correspond to the time from the end of the response frame plus SIFS. In an embodiment, even when SCH is shared with AP2 (i.e., shared AP) within the TXOP, AP2 may not immediately use the SCH but may occupy or use the SCH only after the DSO procedure to SCH with STA2 is completed.

AP2 may exchange frames on SCH (or SC) within the TXOP after the DSO procedure is completed (1280). Meanwhile, AP1, which shared SCH with AP2, may exchange frames on PCH during the remaining time interval of the TXOP (1275).

Meanwhile, while the described an embodiment where the time interval 1290 for the sharing AP to perform DSO ends at the time of the response frame (1255) to the DSO trigger frame (1250) plus SIFS in relation to TXS, Unlike the described embodiment, according to the embodiment illustrated in FIG. 12, AP2 may transmit an MU-RTS trigger frame or RTS trigger frame to STA2 on SCH (or SC) after changing the operating band to SCH through DSO (1265), and STA2 may transmit a CTS frame for response to AP2 (1270).

Further, when AP2 transmits an MU-RTS trigger frame or RTS trigger frame on SCH, AP1 may transmit an MU-RTS trigger frame or RTS trigger frame on PCH (1260), and STA1 may transmit a CTS frame for response to AP1 (1270). As described above, the time interval 1290 required for DSO operation may include not only the time interval for the DSO trigger frame (1250) and response frame (1255) but also the time interval for the sharing AP and shared AP to exchange (MU-)RTS trigger frames and CTS frames in response on PCH and SCH respectively.

According to the illustrated embodiment, when the time interval 1290 required for the DSO procedure includes up to the exchange of RTS frames and CTS frames, the shared AP may substantially occupy or use the SCH shared (or transferred) through TXS from the point when the exchange of RTS frames and CTS frames is completed.

If, according to the previously described embodiment, the time interval 1290 required for the DSO procedure includes only up to the exchange of DSO trigger frames and response frames, the shared AP may occupy or use the SCH shared (or transferred) through TXS from the point of exchanging DSO trigger frames and response frames plus SIFS. In other words, the procedure of AP1 and AP2 exchanging (MU-RTS) trigger frames and CTS frames after DSO trigger frames and response frames are exchanged may or may not be performed, and in each case, the length of the time interval required for the DSO procedure and the starting point and length of the time interval where TXS actually occurs may be defined differently.

For the embodiment described with reference to FIG. 12 above, the ICF (e.g., BSRP trigger frame) that AP1 (sharing AP) transmits to AP2 (shared AP) may include various information or parameters for TXS. For example, the ICF may include not only information about when the MU-RTS TXS trigger frame is transmitted, but also at least one of: information about which AP between the sharing AP and shared AP will perform DSO after transmission of the MU-RTS TXS trigger frame, information about the channel or band to be changed through DSO after transmission of the MU-RTS TXS trigger frame, or information indicating whether the AP performing DSO to operate on SCH will transmit/receive DSO trigger frames and response frames when PCH is shared.

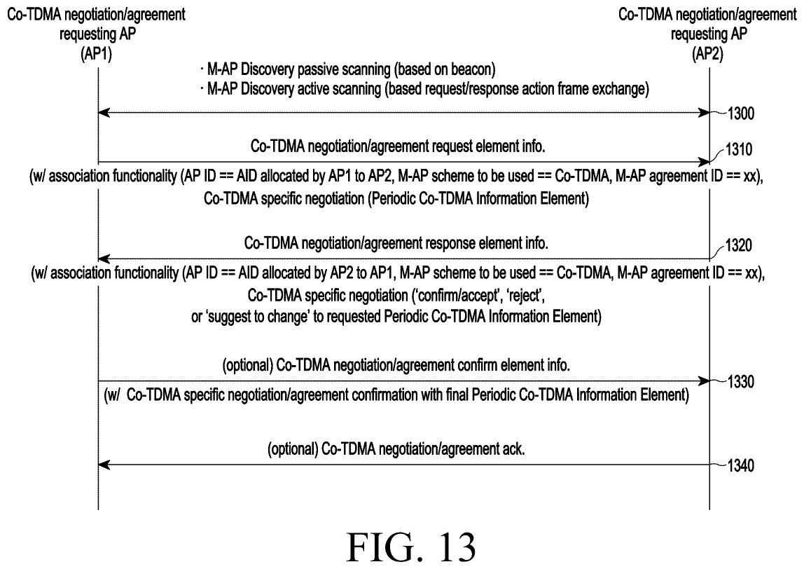

FIG. 13 is a view illustrating an example of negotiation/agreement operation for periodic Co-TDMA operation between access points according to an embodiment of the disclosure.

FIG. 13 is an example of signaling for a first AP (Co-TDMA negotiation/agreement requesting AP) to negotiate (consult) the use of Co-TDMA operation between the first AP and second AP with a second AP (Co-TDMA negotiation/agreement responding AP).

In operation 1300, the first AP and second AP may mutually discover that they are APs supporting M-AP (multiple AP) operation within each other's coverage through an M-AP Discovery passive scanning process or M-AP Discovery active scanning process. In the disclosure, the M-AP operation may specify Co-TDMA.

The M-AP Discovery passive scanning process may be a process in which an AP includes information about M-AP schemes it supports in beacon messages it periodically broadcasts, allowing adjacent APs receiving this beacon to know the M-AP schemes supported by the AP sending the beacon.

The M-AP Discovery active scanning may be a process in which two adjacent APs exchange mutually supportable M-AP schemes and related information through a procedure of transmitting an M-AP discovery request requesting information about M-AP operation support, authentication requirements, security channel formation requirements, etc. by designating an adjacent AP as the destination address of frames such as Public Action frame, Protected dual of Public Action frame, UHR action frame, or Protected UHR Action frame, and the AP receiving this responds with a response.

In operation 1310, according to operation 1300, one AP (first AP) among two APs that have mutually recognized support for the M-AP scheme, particularly Co-TDMA, may transmit a Request frame (e.g., Co-TDMA negotiation/agreement request frame) including Co-TDMA negotiation/agreement request element information to the second AP.

The Co-TDMA negotiation/agreement request element information may include information for M-AP association functionality and Co-TDMA specific negotiation.

The information related to M-AP association functionality may include at least one of the following parameters:
AP ID: AID used by the first AP to refer to the second AP. A value allocated by the first AP to the second AP
Name of the M-AP scheme to be negotiated through the request (e.g., Co-TDMA)

M-AP agreement ID, which is an ID to be used for future status management or operation parameter updates by collectively referring to the M-AP scheme and its operation parameters negotiated through the negotiation/agreement process

The Co-TDMA specific negotiation information related to the M-AP scheme of Co-TDMA to be negotiated through the request may include a periodic Co-TDMA information element.

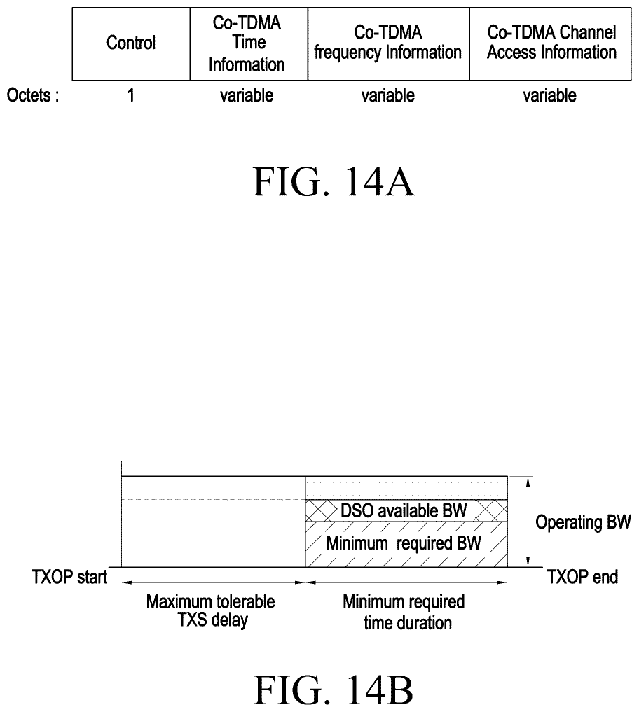

The Periodic Co-TDMA Information element may include detailed information about the periodic Co-TDMA operation that the first AP requests from the second AP, and may include at least one of time information, frequency/bandwidth information, resource information, and channel access parameters, with details referring to FIG. 14A described below.

In an embodiment, the Periodic Co-TDMA Information element included in the Co-TDMA negotiation/agreement request element information may be referred to as a Periodic Co-TDMA Request element.

In operation 1320, the second AP receiving the Co-TDMA negotiation/agreement request element information in operation 1310 may transmit a Response frame (e.g., Co-TDMA negotiation/agreement response frame) including Co-TDMA negotiation/agreement response element information to the first AP in response. Co-TDMA negotiation/agreement response element information may include information for M-AP association functionality and Co-TDMA specific negotiation.

The information related to M-AP association functionality may include at least one of the following parameters:

AP ID: AID used by the second AP to refer to the first AP. A value allocated by the second AP to the first AP.

Name of the M-AP scheme to be negotiated through the request (e.g., Co-TDMA)

M-AP agreement ID, which is an ID to be used for future status management or operation parameter updates by collectively referring to the M-AP scheme and its operation parameters negotiated through the negotiation/agreement process. May be transmitted with the same value as transmitted by the first AP or may be omitted.

The Co-TDMA specific negotiation information related to the M-AP scheme of Co-TDMA to be negotiated through the request may include a periodic Co-TDMA information element.

The Periodic Co-TDMA Information element may include details about the periodic Co-TDMA operation that the first AP requested from the second AP in operation 1310, and may include at least one of time information, frequency/bandwidth information, and channel access parameters, with details referring to FIG. 14A described below.

In particular, the Co-TDMA negotiation/agreement response element information may include a status code indicating whether the second AP accepts/approves, rejects, or counter-proposes alternative parameters for the negotiation content included in the Co-TDMA specific negotiation information transmitted by the first AP and, when counter-proposing alternative parameters, the Periodic Co-TDMA Information element may include time information, frequency/bandwidth information, resource information, channel access parameters, etc. acceptable to the second AP.

In an embodiment, the Periodic Co-TDMA Information element included in the Co-TDMA negotiation/agreement response element information may be referred to as a Periodic Co-TDMA Response element.

In operation 1330, the first AP receiving a response from the second AP according to operation 1320 may optionally transmit a frame including Co-TDMA negotiation/agreement identify element information to the second AP to indicate final approval of the negotiation. This may explicitly mean that the first AP has received the second AP's response and finally approves the negotiation content.

In an embodiment, if the first AP does not want to negotiate Co-TDMA, the identify element information may include an indicator meaning rejection of the negotiation content and breakdown of negotiations.

In operation 1340, the second AP may optionally transmit an acknowledge for the content of the Co-TDMA negotiation/agreement identify element information received from the first AP in operation 1330.

Operations 1330 and 1340 may be optionally performed according to standard specifications or implementation.

In the disclosure, the terms “negotiation” and “agreement” may be used together, both meaning an operation to form an agreement on specific parameters or functions between two or more devices or network entities. Therefore, even when the term “negotiation” or “agreement” is written alone in this specification, it may be understood to include the content described with the counterpart term.

The frame used in each operation (operations 1300, 1310, 1320, 1330, 1340) between two APs in FIG. 13 may be one of the Public Action frame, Protected dual of Public Action frame, UHR Action frame, or Protected UHR Action frame described with reference to FIGS. 15A, 15B, and 15C.

In an embodiment, the first AP and second AP may perform the operations of operations 1310, 1320, 1330, 1340 by exchanging roles.

For example, the first AP may receive a Request frame (e.g., Co-TDMA negotiation/agreement request frame) including Co-TDMA negotiation/agreement request element information from the second AP, and may transmit a Response frame (e.g., Co-TDMA negotiation/agreement response frame) including Co-TDMA negotiation/agreement response element information to the second AP in response to the Request frame.

For example, the second AP may transmit a Request frame (e.g., Co-TDMA negotiation/agreement request frame) including Co-TDMA negotiation/agreement request element information to the first AP, and may receive a Response frame (e.g., Co-TDMA negotiation/agreement response frame) including Co-TDMA negotiation/agreement response element information from the first AP in response to the Request frame.

FIGS. 14A and 14B are diagrams describing an example of a periodic Co-TDMA Request element format including Co-TDMA operation related information according to various embodiments of the disclosure.

FIG. 14A illustrates an example of a Periodic Co-TDMA Request element format included in Co-TDMA negotiation/agreement request element information.

In an embodiment, the Periodic Co-TDMA Request element format illustrated in FIG. 14A may correspond to the Periodic Co-TDMA Information element format included in the Co-TDMA negotiation/agreement request element information of operation 1310 of FIG. 13.

In an embodiment, the same structure and parameters as the Periodic Co-TDMA Request element format illustrated in FIG. 14A may be equally applied to the Periodic Co-TDMA Information element format included in the Co-TDMA negotiation/agreement response element information of operation 1320.

Referring to FIG. 14A, the Periodic Co-TDMA Request element format may include at least one of the following fields:
Control field
Co-TDMA Time Information field
Co-TDMA frequency Information field
Co-TDMA Channel Access Information field

The Control field may include an indicator indicating whether the requested Co-TDMA negotiation content is a periodic Co-TDMA request and an indicator indicating whether the frame includes fields indicating the Co-TDMA Time Information, Co-TDMA frequency Information, and Co-TDMA Channel Access Information.

The Co-TDMA Time Information field may include at least one of the following parameters:
Periodic Co-TDMA Start Time: The request start time for receiving the earliest Co-TDMA (or TXS) from the time of sending the periodic Co-TDMA agreement request
Periodic Co-TDMA Interval: The interval of periodic Co-TDMA
Minimum required T×S duration (Minimum required time duration): The minimum shared TXOP duration to be received from this Co-TDMA
Maximum tolerable TXS delay: The maximum waiting time from the periodic Co-TDMA transfer request time until receiving the transfer

The Co-TDMA Frequency Information may include at least one of the following parameters or elements:
Minimum required BW: The minimum bandwidth value of TXOP that the Co-TDMA Requesting AP may receive
Bandwidth Indication Element: Operating BW information about which the Co-TDMA Requesting AP is currently operating
DSO availability: Whether TXOP transfer with DSO operation in Shared TXOP is possible and related control information
DSO Bandwidth Indication Element: Bandwidth information operable when involving DSO operation in Shared TXOP (DSO available BW)

Upon receiving the Co-TDMA Frequency Information field included in the periodic Co-TDMA Request element format, the second AP may identify the frequency at which the Co-TDMA operation may be performed by the first AP and the second AP according to the received information. More specifically, through the bandwidth indication element included in the Co-TDMA Frequency Information, it is possible to determine which of the bandwidths in operation of the first AP and the second AP are overlapping. Furthermore, through the minimum required BW information, the initial bandwidth value for the first AP and the second AP to perform Co-TDMA may be identified. Furthermore, through the DSO Bandwidth Indication Element, frequency or channel information that may be operated by the DSO may be identified in case that the first AP and the second AP involve a DSO during the Co-TDMA operation.

The Co-TDMA Channel Access Information is mainly used to include information for the Co-TDMA requested AP to accept the request under predetermined conditions, and may include at least one of the following parameters:
EDCA parameters: EDCA parameters to be used in TXOP operating Co-TDMA (Co-TDMA responding AP may demand/dictate EDCA parameters)
Available access category (AC): AC processable within Periodic Co-TDMA TXOP

FIG. 14B is a view illustrating and describing the parameters constituting the Periodic Co-TDMA Request element field described with reference to FIG. 14A.

FIG. 14B illustrates the parameters described with reference to FIG. 14A—Maximum tolerable TXS delay, Minimum required time duration, Operating BW, Minimum required BW, DSO available BW-on a graph with time on the horizontal axis and frequency/bandwidth on the vertical axis.

TXOP start means the time when the second AP (Co-TDMA negotiation/agreement responding AP) obtains the TXOP. The second AP is an AP that transfers the remaining TXOP to the first AP according to the first AP's Co-TDMA request, so it may be referred to as a TXOP sharing AP.

FIGS. 15A, 15B, and 15C are views illustrating an action frame according to various embodiments of the disclosure.

FIG. 15A illustrates an example of an Action field format included in an action frame defined in the IEEE 802.11 standard.

The Action field illustrated in FIG. 15A may be included in the frame body of an action frame indicated through the type field and subtype field of a MAC frame in the MAC Header within the MAC frame format illustrated in FIG. 4.

Referring to FIG. 15A, the Action field may include a Category field and an Action Details field.

The Category field is a field indicating the category of the action frame and may be set to one of the values predefined in the IEEE 802.11 standard for action frame categories, with examples of category names and corresponding values illustrated in FIG. 15B. An action frame of a specific category may be referred to as a “category name” action frame.

For example, when the value of the Category field is set to a value (e.g., xx) referring to the UHR category, it may indicate that the frame is a “UHR Action frame”. The UHR Action frame may refer to one of the Action frames for operating operations related to UHR characteristics.

For example, the Category field may be set to a value referring to the Protected UHR category to indicate that the frame is a Protected UHR Action frame. In an embodiment, a Protected UHR Action frame is one of the Action frames for operating operations related to UHR characteristics, and may particularly refer to an Action frame transmitted between authenticated and associated APs and STAs (or between STAs).

The Action Details field may include details of the action frame referred to in the Category field. The Action Details field may include different details for each action frame referred to in the Category field.

The Action Details field may include a field indicating a detailed category, and examples of Action Details field values are illustrated in FIG. 15C.

FIG. 15C illustrates examples of values that may be set in the UHR Action field of a UHR Action frame, the Protected UHR Action field of a Protected UHR Action frame, or the Public Action field of a Public Action frame or Protected dual of Public Action frame.

Referring to FIG. 15C, according to the values of the UHR Action field, Protected UHR Action field, or Public Action field, it may indicate that the corresponding action frame is a request frame, response frame, or notification frame for a specific UHR feature.

Referring to FIG. 15C, according to the values of the UHR Action field, Protected UHR Action field, or Public Action field (e.g., Xx7, Xx8, Xx9), it may indicate that the corresponding action frame is an M-AP (Co-TDMA) agreement request frame, M-AP (Co-TDMA) agreement response frame, or M-AP (Co-TDMA) agreement identification frame.

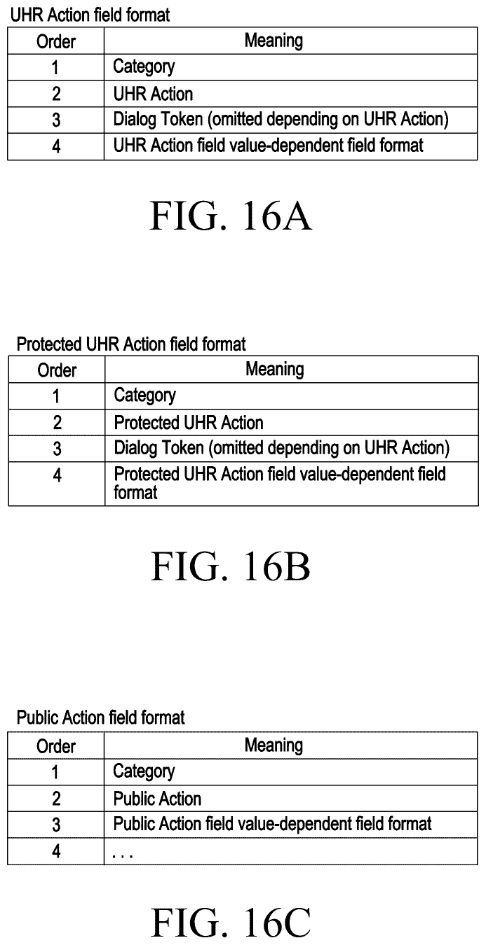

FIGS. 16A, 16B, and 16C are views illustrating an example of an Action field format of an action frame according to various embodiments of the disclosure.

FIG. 16A illustrates an Action field format of a UHR Action frame according to an embodiment. The UHR Action frame may include fields indicating the corresponding information in the order illustrated in FIG. 16A.

Referring to FIG. 16A, the Action field format of a UHR Action frame may include at least one of a Category field, UHR Action field, Dialog Token field, and UHR Action field value-dependent field format.

The Category field may include a value indicating the category of the UHR Action frame as described above.

The UHR Action field may include a value indicating the detailed category of the corresponding action frame, and examples of values that may be included may be referred to in FIG. 15C.

The Dialog Token field may include a non-zero random value for identifying the association (or transaction) between request and response messages, and may be omitted according to the UHR Action.

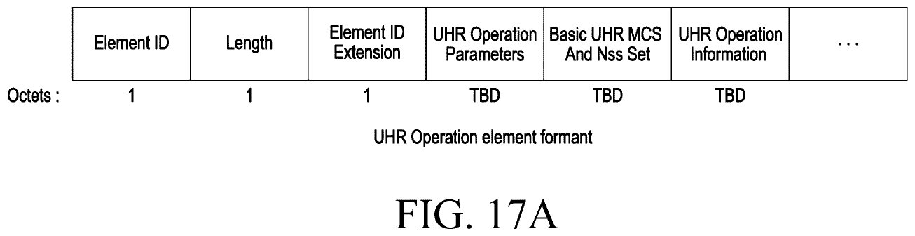

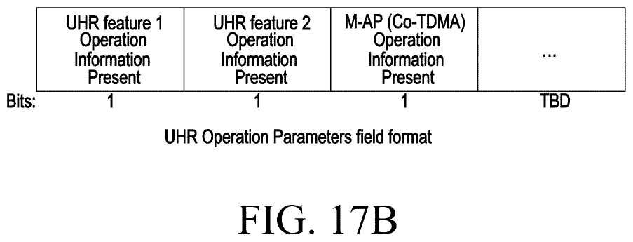

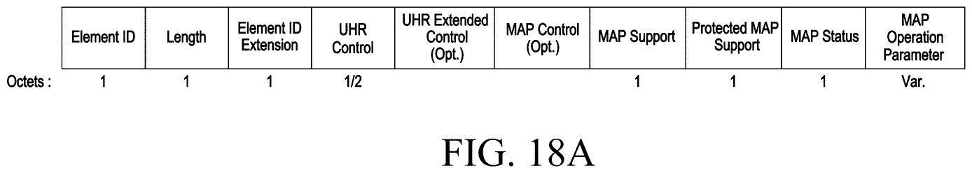

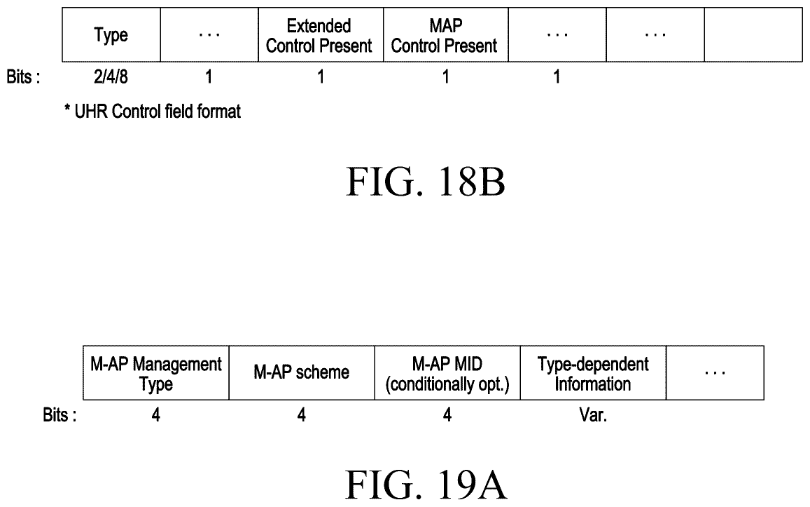

The UHR Action field value-dependent field format may include specific fields according to the UHR Action field value, or may be defined as the corresponding element (e.g., UHR Operation element or Co-TDMA Operation Information element). Examples of this are described with reference to FIGS. 17A and 18A.

FIG. 16B illustrates an Action field format of a Protected UHR Action frame according to an embodiment. A Protected UHR Action frame may include fields indicating the corresponding information in the order illustrated in FIG. 16B.

Referring to FIG. 16B, the Action field format of a Protected UHR Action frame may include at least one of a Category field, Protected UHR Action field, Dialog Token field, and Protected UHR Action field value-dependent field format.

The Category field may include a value indicating the category of the Protected UHR Action frame as described above.

The Protected UHR Action field may include a value indicating the detailed category of the corresponding action frame, and examples of values that may be included may be referred to in FIG. 15C.

The Dialog Token field may include a non-zero random value for identifying the association (or transaction) between request and response messages, and may be omitted according to the Protected UHR Action.

The Protected UHR Action field value-dependent field format may include a specific field format according to the Protected UHR Action field value, or may be defined as the corresponding element (e.g., UHR Operation element or Co-TDMA Operation Information element). Examples of this are described with reference to FIGS. 17A and 18A.

FIG. 16C illustrates an Action field format of a Public Action frame (or Protected dual of Public Action frame) according to an embodiment. A Public UHR Action frame (or Protected dual of Public Action frame) may include fields indicating the corresponding information in the order illustrated in FIG. 16C.

Referring to FIG. 16C, the Action field format of a Public Action frame (or Protected dual of Public Action frame) may include at least one of a Category field, Public Action field, and Public Action field value-dependent field format.

The Category field may include a value indicating the category of the Public Action frame (or Protected dual of Public Action frame) as described above.

The Public Action field may include a value indicating the detailed category of the corresponding action frame, and examples of values that may be included may be referred to in FIG. 15C.

The Public Action field value-dependent field format may include a specific field format according to the Public Action field value, or may be defined as the corresponding element (e.g., UHR Operation element or Co-TDMA Operation Information element). Examples of this are described with reference to FIGS. 17A and 18A.

FIG. 17A is a view illustrating an example of a UHR Operation element format according to an embodiment of the disclosure.

FIG. 17B is a view illustrating an example of a UHR Operation Parameters field format according to an embodiment of the disclosure.

FIG. 17A illustrates a UHR Operation element format, and FIG. 17B illustrates an example of the field format of the UHR Operation Parameters field illustrated in FIG. 17A.

In an embodiment, the Action field value-dependent field of each Action field format illustrated in FIGS. 16A, 16B, and 16C may be defined as a UHR Operation element with the structure illustrated in FIG. 17A, or may be configured including at least one of the fields with the structure illustrated in FIG. 17A.

Referring to FIG. 17A, the UHR Operation element format may include at least one of an Element ID field, Length field, Element ID Extension field, UHR Operation Parameters field, Basic UHR modulation and coding scheme (MCS) And number of spatial streams (NSS) set field, and UHR Operation Information field.

The element ID and element ID extension field may indicate that the corresponding element represents a UHR Operation element.

The Length field may indicate the length of information transmitted through the corresponding element.

The UHR Operation Parameters field is a field including configuration parameters used for UHR operation, and FIG. 17B illustrates an example thereof.

The Basic UHR MCS And NSS set field may indicate the modulation and coding scheme (MCS) and number of spatial streams (NSS) used for UHR operation.

The UHR Operation Information field may indicate information used for UHR operation. For example, the UHR Operation Information field may include a Co-TDMA Operation Information field, and the Co-TDMA Operation Information field may be defined as an element with the structure illustrated in FIG. 18A, or may be configured including at least one field with the structure illustrated in FIG. 18A.

Referring to FIG. 17B, the UHR Operation Parameters field may include subfields (UHR feature 1 Operation Information Present subfield, UHR feature 2 Operation Information Present subfield) indicating whether at least one UHR feature (e.g., NPCA, DSO, etc.) operation is activated and/or whether a field for UHR feature (e.g., NPCA, DSO, etc.) operation information is present.

Further, referring to FIG. 17B, the UHR Operation Parameters field may include an M-AP (or Co-TDMA) Operation Information Present subfield indicating whether M-AP (or Co-TDMA) operation is activated in the AP transmitting the corresponding field and/or whether a field (Co-TDMA Operation Information field) for M-AP (or Co-TDMA) operation information is present within the UHR Operation Information field.

For example, when the value of the M-AP (or Co-TDMA) Operation Information Present subfield is 1, it may indicate that M-AP (or Co-TDMA) operation is activated in the AP transmitting the corresponding field, and/or that the Co-TDMA Operation Information field is present within the UHR Operation Information field.

For example, when the value of the M-AP (or Co-TDMA) Operation Information Present subfield is 0, it may indicate that M-AP (or Co-TDMA) operation is not activated in the AP transmitting the corresponding field, and/or that the Co-TDMA Operation Information field is not present within the UHR Operation Information field.

FIGS. 18A and 18B are views illustrating an example of a Co-TDMA Operation element format that may include Co-TDMA operation related information according to various embodiments of the disclosure.

The Co-TDMA Operation element format may include the whole or part of the Co-TDMA negotiation/agreement request element information or Co-TDMA negotiation/agreement response element format of FIG. 13.

The Co-TDMA Operation element format may be included in one of the Public Action frame, Protected dual of Public Action frame, UHR Action frame, or Protected UHR Action frame described with reference to FIG. 9 and transmitted between the Co-TDMA negotiation/agreement requesting AP and Co-TDMA negotiation/agreement responding AP in the AP-to-AP Co-TDMA negotiation/agreement operations illustrated in FIG. 13 (operations 1300, 1310, 1320, 1330, 1340). FIG. 18A illustrates an example of a Co-TDMA Operation element format that may include Co-TDMA operation related information.

In an embodiment, the Action field value-dependent field of each Action field format illustrated in FIGS. 16A, 16B, and 16C may be defined as a Co-TDMA Operation element with the structure illustrated in FIG. 18A, or may include at least one field with the structure illustrated in FIG. 18A.

In an embodiment, the UHR Operation Information field included in the UHR Operation element format illustrated in FIG. 17A may be defined as a Co-TDMA Operation element with the structure illustrated in FIG. 18A, or may include at least one field with the structure illustrated in FIG. 18A.

Referring to FIG. 18A, the Co-TDMA Operation element format may include at least some of an Element ID field, Length field, Element ID Extension field, UHR Control field, UHR Extended Control field, MAP Control field, MAP Support field, Protected MAP Support field, MAP Status field, or MAP Operation Parameter field.

The Element ID field and element ID extension field may indicate that the corresponding element is a Co-TDMA Operation element.

The Length field may include a value for the length of information transmitted through the Co-TDMA Operation element.

The UHR Control field may include values related to control of Co-TDMA Operation. In this case, the configuration of subfields constituting the UHR Control field is specifically described with reference to FIG. 18B below.

The UHR Extended Control field may indicate an extension value of the UHR Control field.

The MAP Control field may include values related to control of MAP operation.

The UHR Extended Control field and MAP Control field may be optionally included as needed.

The MAP Support field may include information about M-AP schemes supported by the AP transmitting the frame including the corresponding element.

The Protected MAP Support field may include information about M-AP schemes (or specific features) requiring security among the M-AP schemes supported by the AP transmitting the frame including the corresponding element. For example, the need for security for specific features may include cases where security needs may be applied differently according to beam type in the case of C-BF. However, the Protected MAP Support field may be omitted in some cases.

In an embodiment, when the MAP Support field only includes information about M-AP schemes supported by the AP transmitting the frame including the corresponding element, the Co-TDMA Operation element format may include a Protected MAP Support field. In this case, the Protected MAP Support field may include information about the need for security for each of the M-AP schemes included in the MAP Support field.

In another embodiment, when the MAP Support field includes information about M-AP schemes supported by the AP transmitting the frame including the corresponding element and information about the need for security for each M-AP scheme, the Co-TDMA Operation element format may not include the Protected MAP Support field.

In another embodiment, when the UHR Control field indicates that security is not needed, the Co-TDMA Operation element format may not include the Protected MAP Support field.

The MAP Status field may indicate status information about MAP operation of the AP transmitting the frame including the corresponding element. The MAP status field may include subfields indicating information about the M-AP status formed by the AP transmitting the beacon frame. For example, the MAP status field may include a Num of M-AP agreements field and an M-AP agreement info field.

The Num of M-AP agreements field includes 1 octet and may indicate the number of M-AP agreements the AP has made.

The M-AP agreement info field includes 8 octets or more and may include an information set composed of {M-AP scheme, AP MAC address, Type}. In this case, the M-AP scheme includes 1 octet and may be represented in bitmap form (e.g., bit 0: C-TDMA, bit 1: C-SR, bit 2: C-BF, . . . ). The AP MAC address includes 6 octets and may indicate the MAC address of the counterpart AP that formed the M-AP scheme. Type includes 1 octet and may include other information about M-AP agreement (e.g., Protected: whether Protected M-AP scheme is used).

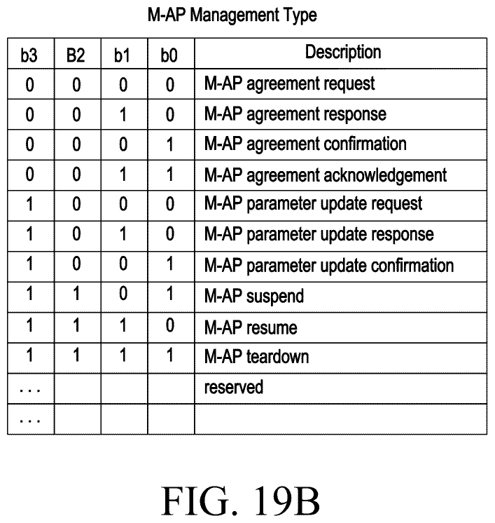

The MAP Operation Parameter field is a field including configuration parameters used for MAP operation (or Co-TDMA operation), and FIG. 19A illustrates an example of the MAP Operation Parameter field format.

FIG. 18B illustrates an example of the UHR Control field format of the UHR Control field described with reference to FIG. 18A.

Referring to FIG. 18B, the UHR Control field format may include a Type subfield and Present subfields indicating whether fields corresponding to the Co-TDMA Operation element format exist, such as Extended Control Present subfield and MAP Control Present subfield.

The Type subfield may indicate type information about MAP operation of the AP transmitting the frame including the corresponding element. Type includes 1 octet and may include other information about M-AP agreement (e.g., Protected: whether Protected M-AP scheme is used).

FIGS. 19A and 19B are views illustrating an example of a MAP Operation Parameter field format for Co-TDMA related negotiation according to various embodiments of the disclosure.

FIG. 19A is a diagram describing an example of a MAP Operation Parameter field format according to an embodiment of the disclosure.

In an embodiment, FIG. 19A illustrates an example of a MAP Operation Parameter field format that may be included in a Request frame or Response frame for negotiation/agreement of Co-TDMA operation.

FIG. 19A illustrates an example of the field format of the MAP Operation Parameter field included in the Co-TDMA Operation element format illustrated in FIG. 18A.

Referring to FIG. 19A, the MAP Operation Parameter field format may include at least one of an M-AP Management Type field, M-AP scheme field, M-AP MID field, and Type-dependent Information field.

The M-AP Management Type field may indicate one of the management types that the corresponding frame intends to perform for M-AP operation.

Establishment of a new M-AP scheme agreement: For example, it may indicate whether the parameter or element included in the Type-dependent Information field of the MAP Operation Parameter field format is for M-AP agreement request, response, identification, or acknowledgement.

Parameter update for an M-AP scheme agreement: For example, it may indicate whether the parameter or element included in the Type-dependent Information field of the MAP Operation Parameter field format is for M-AP parameter update request, response, or identification.

Status change of an M-AP agreement: For example, it may indicate whether the parameter or element included in the Type-dependent Information field of the MAP Operation Parameter field format is for M-AP suspend, resume, or teardown.

In an embodiment, the M-AP Management Type field may indicate one of the management types that the corresponding frame intends to perform for M-AP operation using a preset table, an example of which is illustrated in FIG. 19B.

Referring to FIG. 19B, when the M-AP Management Type field includes a value of b0000, it may indicate that the parameter included in the Type-dependent Information field is a parameter for M-AP agreement request.

The M-AP scheme field may refer to the M-AP scheme to be formed through the corresponding frame (e.g., Co-TDMA)

The M-AP MID (M-AP agreement ID) field may be an indicator collectively indicating the M-AP agreement and related operation parameters negotiated through the corresponding frame. In an embodiment, the M-AP MID field may be included in a frame for updating the status (suspend, resume, terminate, etc.) or operation parameters of an M-AP agreement, and may be used to update the status or operation parameters of the M-AP agreement by referring to operation parameters related to the M-AP agreement corresponding to the M-AP MID field value.

The Type-dependent Information field may include parameters or elements corresponding to values of at least one of the M-AP Management Type field and M-AP Scheme field.

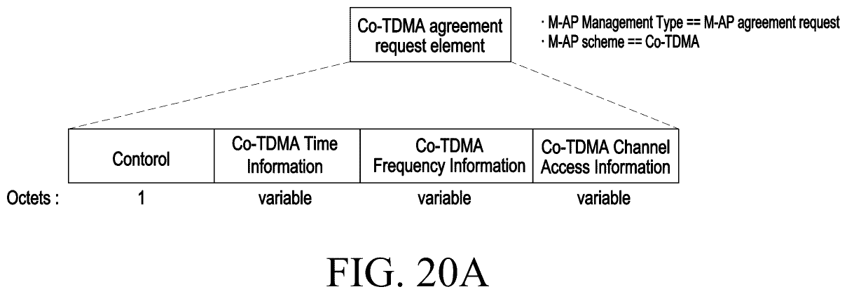

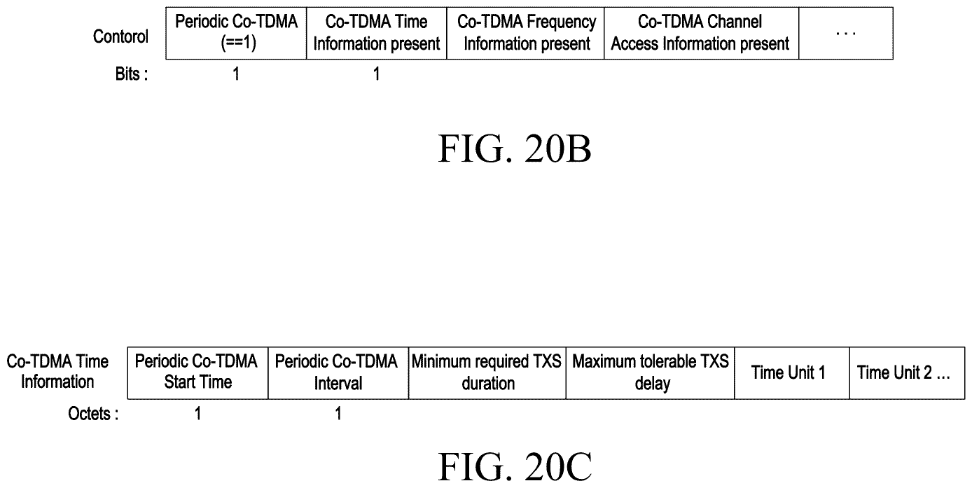

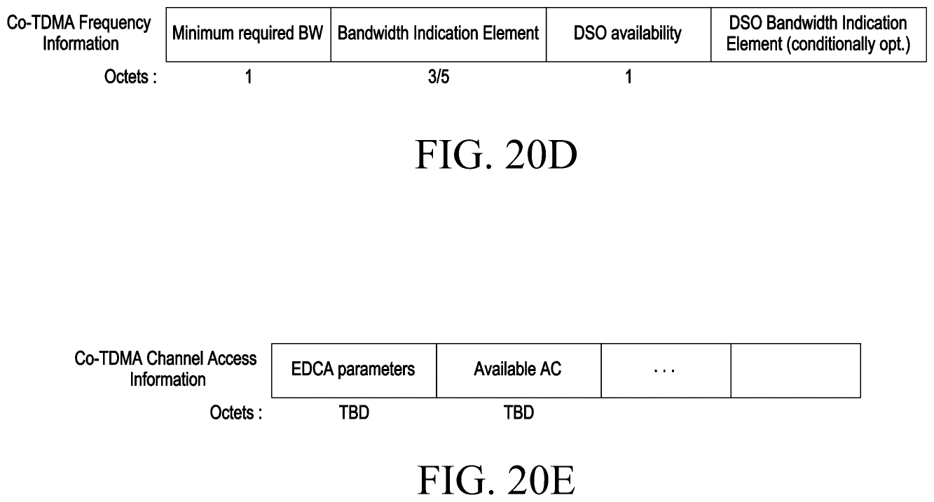

FIGS. 20A, 20B, 20C, 20D, and 20E are views illustrating an example of a Co-TDMA agreement request element format that may be included in the Type-dependent Information field of the MAP Operation Parameter field of an action frame according to various embodiments of the disclosure.

FIG. 20A illustrates an example of a Co-TDMA agreement request element format including information for Co-TDMA operation and, when the M-AP Management Type field of the MAP Operation Parameter field format illustrated in FIG. 19A indicates M-AP agreement request and the M-AP scheme field indicates Co-TDMA, the Type-dependent information field may be defined as a Co-TDMA agreement request element with the structure illustrated in FIG. 20A.

In an embodiment, the Co-TDMA agreement request element may be referred to as a Co-TDMA negotiation/agreement request element.

Referring to FIG. 20A, the Co-TDMA agreement request element format may include at least one of the following fields:
Control field
Co-TDMA Time Information field
Co-TDMA frequency Information field
Co-TDMA Channel Access Information field

The description of each field in FIG. 20A may refer to the description of fields with the same names in FIG. 14A.

FIG. 20B illustrates the field format of the Control field illustrated in FIG. 20A.

Referring to FIG. 20B, the Control field may include at least one of a Periodic Co-TDMA subfield, Co-TDMA Time Information Present subfield, Co-TDMA frequency Information Present subfield, and Co-TDMA Channel Access Information Present subfield.

The Periodic Co-TDMA subfield may include an indicator indicating whether the requested Co-TDMA negotiation content is a periodic Co-TDMA request. For example, when the Periodic Co-TDMA subfield indicates a value of 1, it may indicate that the requested Co-TDMA negotiation content is a periodic Co-TDMA request. For example, when the Periodic Co-TDMA subfield indicates a value of 0, it may indicate that the requested Co-TDMA negotiation content is an aperiodic Co-TDMA request.

The Co-TDMA Time Information Present subfield, Co-TDMA frequency Information Present subfield, and Co-TDMA Channel Access Information Present subfield may include indicators indicating whether the corresponding frame includes fields indicating the Co-TDMA Time Information, Co-TDMA frequency Information, and Co-TDMA Channel Access Information.

FIG. 20C illustrates the field format of the Co-TDMA Time Information field illustrated in FIG. 20A.

Referring to FIG. 20C, the Co-TDMA Time Information field format may include at least one of a Periodic Co-TDMA Start Time field, Periodic Co-TDMA Interval field, Minimum required T×S duration (Minimum required time duration) field, Maximum tolerable TXS delay field, and at least one Time Unit field.

The Periodic Co-TDMA Start Time field may indicate the request start time for receiving the earliest Co-TDMA from the time of transmitting the Co-TDMA agreement request.

The Periodic Co-TDMA Interval field may indicate the interval of periodic Co-TDMA.

The Minimum required T×S duration (Minimum required time duration) field may indicate the minimum shared TXOP duration to be received from this Co-TDMA.

The Maximum tolerable TXS delay field may indicate the maximum waiting time from the periodic Co-TDMA transfer request time (e.g., the time indicated in the Periodic Co-TDMA Start Time field) until receiving the transfer.

FIG. 20D illustrates the field format of the Co-TDMA Frequency Information field illustrated in FIG. 20A.

Referring to FIG. 20D, the Co-TDMA Frequency Information field format may include at least one of a Minimum required BW field, Bandwidth Indication element, DSO availability field, and DSO Bandwidth Indication element.

The Minimum required BW field may indicate the minimum bandwidth value of TXOP that the Co-TDMA Requesting AP may receive.

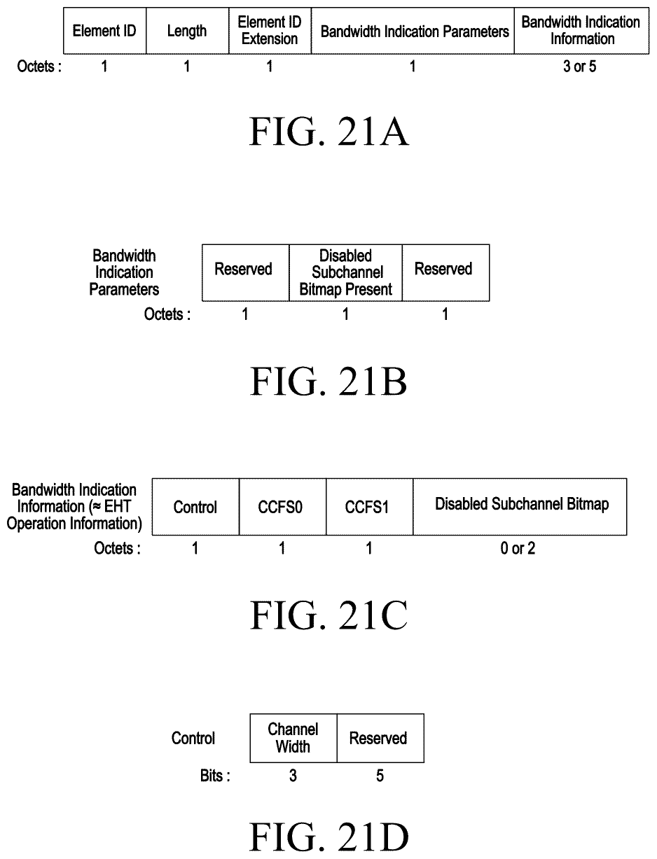

The Bandwidth Indication element is an element for Operating BW on which the Co-TDMA Requesting AP is currently operating, and may be defined, e.g., as the Bandwidth Indication element illustrated in FIG. 21A.

The DSO availability field may include whether TXOP transfer with DSO operation in Shared TXOP is possible and related control information.

The DSO Bandwidth Indication element may include bandwidth information (DSO available BW) operable when involving DSO operation in Shared TXOP.

Upon receiving the Co-TDMA Frequency Information field included in the periodic Co-TDMA Response element format, the second AP may identify the frequency at which the Co-TDMA operation may be performed by the first AP and the second AP according to the received information. More specifically, through the bandwidth indication element included in the Co-TDMA Frequency Information, it is possible to determine which of the bandwidths in operation of the first AP and the second AP are overlapping. Furthermore, through the minimum required BW information, the initial bandwidth value for the first AP and the second AP to perform Co-TDMA may be identified. Furthermore, through the DSO Bandwidth Indication Element, frequency or channel information that may be operated by the DSO may be identified in case that the first AP and the second AP involve a DSO during the Co-TDMA operation.

FIG. 20E illustrates the field format of the Co-TDMA Channel Access Information field illustrated in FIG. 20A.

Referring to FIG. 20E, the Co-TDMA Channel Access Information field format may include at least one of an EDCA parameters field and an Available AC

### FIELD

The EDCA parameters field may include at least one EDCA parameter to be used in TXOP operating Co-TDMA. In an embodiment, the at least one EDCA parameter may be demanded and/or dictated by the Co-TDMA responding AP.

The Available AC (access category) field may indicate AC processable within Periodic Co-TDMA TXOP.

FIGS. 21A, 21B, 21C, and 21D are views illustrating an example of a Bandwidth Indication element format including Co-TDMA related information according to various embodiments of the disclosure.

FIG. 21A illustrates the element format of the Bandwidth Indication element of the Co-TDMA Frequency Information field format illustrated in FIG. 20D.

Referring to FIG. 21A, the Bandwidth Indication element format may include at least one of an Element ID field, Length field, Element ID Extension field, Bandwidth Indication Parameters field, and Bandwidth Indication Information field.

The element ID and element ID extension field may indicate that the corresponding element is a Bandwidth Indication element.

The Length field may indicate the length of information transmitted through the corresponding element.

The Bandwidth Indication Parameters field may indicate whether fields necessary for bandwidth indication are present.

FIG. 21B illustrates an example of the field format of the Bandwidth Indication Parameters field, and referring to FIG. 21B, the Bandwidth Indication Parameters field format may include a Disabled Subchannel Bitmap Present field and a Reserve field.

The Disabled Subchannel Bitmap Present field may indicate whether a Disabled Subchannel Bitmap field is present in the Bandwidth Indication Information field of the corresponding element.

The Bandwidth Indication Information field illustrated in FIG. 21A may include information about Operating BW on which the Co-TDMA Requesting AP is currently operating. FIG. 21C illustrates an example of the Bandwidth Indication Information field, and referring to FIG. 21C, the Bandwidth Indication Information field may include at least one of a Control field, at least one channel center frequency segment (CCFS) field, and a Disabled Subchannel Bitmap field.

An example of the field format of the Control field is illustrated in FIG. 21D, and referring to FIG. 21D, the Control field may include a Channel Width field.

The Channel Width field may indicate the (UHR) BSS channel width of the corresponding AP. For example, when the Channel Width field value is 0, it may indicate 20 MHz; when the value is 1, 20 MHz; when the value is 2, 80 MHz; when the value is 3, 160 MHz; and when the value is 4, 320 MHz.

The at least one CCFS field illustrated in FIG. 21C may indicate the channel center frequency index on which the (UHR) BSS of the corresponding AP operates. For example, the channel center frequency index may include an index for a 20, 40, 80, 160, or 320 MHz channel.

The Disabled Subchannel Bitmap field illustrated in FIG. 21C may be present when the Disabled Subchannel Bitmap Present field illustrated in FIG. 21B includes a value (e.g., 1) indicating that the Disabled Subchannel Bitmap field is present. The Disabled Subchannel Bitmap field may provide a list of punctured (i.e., unusable) subchannels within the BSS bandwidth.

In an embodiment, the Disabled Subchannel Bitmap field is a 16-bit bitmap, where the lowest numbered bit may correspond to the lowest frequency 20 MHz subchannel among the 20 MHz subchannels included within the BSS bandwidth. Each successive bit in the bitmap corresponds to the next 20 MHz subchannel with a higher frequency. When a bit in the bitmap is set to 1, it indicates that the corresponding 20 MHz subchannel is punctured and, when a bit is set to 0, it indicates that the corresponding 20 MHz subchannel is not punctured.

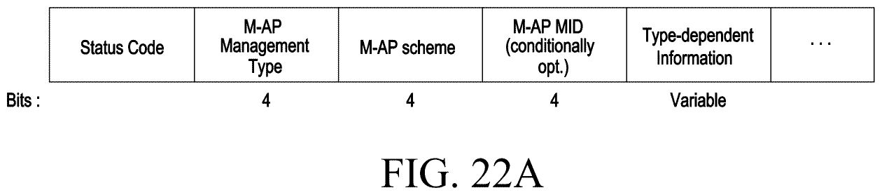

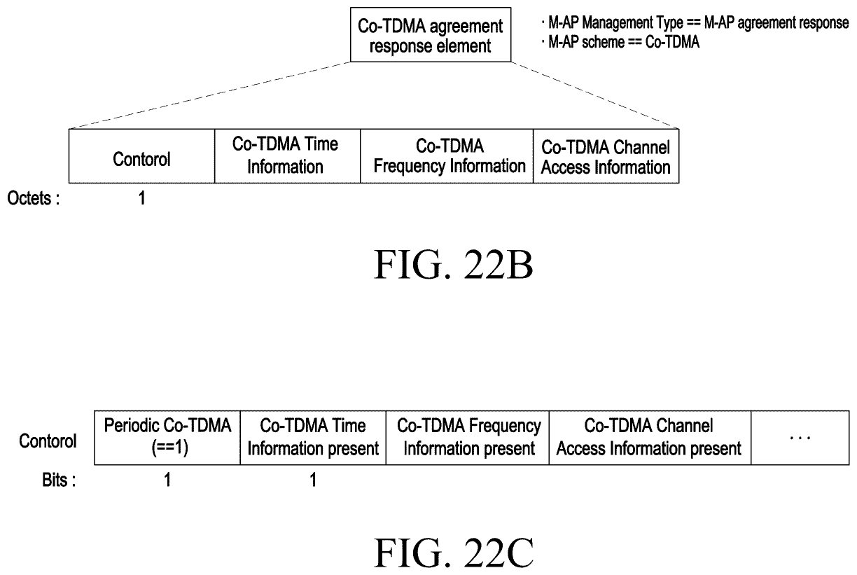

FIGS. 22A, 22B, and 22C are views illustrating an example of a MAP Operation Parameter field format and Co-TDMA Response element format that may be included in a Response frame for negotiation/agreement of Co-TDMA operation according to various embodiments of the disclosure.

Referring to FIG. 22A, the MAP Operation Parameter field format that may be included in a Response frame for negotiation/agreement of Co-TDMA operation may include a Status Code field, M-AP Management Type field, M-AP scheme field, M-AP MID field, and Type-dependent Information field. The description of the M-AP Management Type field, M-AP scheme field, M-AP MID field, and Type-dependent Information field may refer to the description of fields with the same names in FIG. 19A.

Referring to FIG. 22A, when the M-AP Management Type field of the Co-TDMA Operation element indicates M-AP agreement response and the M-AP scheme field indicates Co-TDMA, the Type-dependent Information field may be defined as a Co-TDMA agreement response element.

The Status Code field may include information (or values) indicating Accept, Reject, Dictate, Suggest, etc. for the Co-TDMA negotiation/agreement request. The Status Code field may include status code values defined in IEEE 802.11 (e.g., values indicating SUCCESS, DENIED, REJECTED, etc.).

In an embodiment, the Status Code field may include a status code value proposing preferred Co-TDMA operation related parameters.

In an embodiment, the Status Code field may include a status code value indicating that the request is rejected because the requested Co-TDMA operation related parameters may not be accepted.

The Type-dependent Information field may include a Co-TDMA agreement response element. When the Status Code field includes a status code value proposing preferred Co-TDMA operation related parameters, the Co-TDMA agreement response element may include information for the proposed Co-TDMA operation related parameters, an example of which is illustrated in FIG. 22B.

Referring to FIG. 22B, the Co-TDMA agreement response element format may include at least one of the following fields:
Control field
Co-TDMA Time Information field
Co-TDMA frequency Information field
Co-TDMA Channel Access Information field

The description of each field in FIG. 22B may refer to the description of fields with the same names in FIG. 14A.

FIG. 22C illustrates the field format for the Control field of FIG. 22B, and the description of each field may refer to the description of fields with the same names in FIG. 20B.

In an embodiment, the values of the Co-TDMA Time Information field, Co-TDMA frequency Information field, and Co-TDMA Channel Access Information field included in the Co-TDMA agreement response element format illustrated in FIG. 22B may be set to values acceptable to the Co-TDMA responding AP and transmitted to the Co-TDMA requesting AP.

In an embodiment, when it is unnecessary for the Co-TDMA responding AP to set acceptable values for Co-TDMA operation related parameters, the values of the Co-TDMA Time Information Present subfield, Co-TDMA frequency Information Present subfield, and Co-TDMA Channel Access Information Present subfield in FIG. 22C may be set to values (e.g., 0) indicating that the corresponding field is not present.

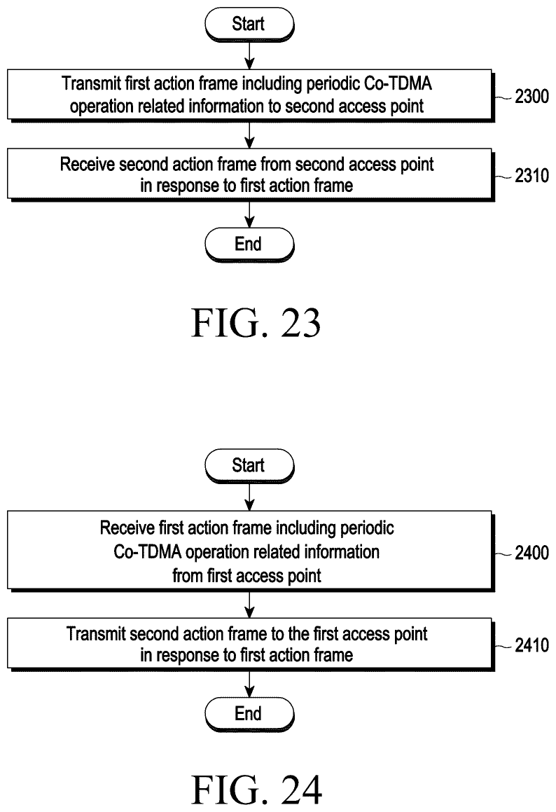

FIG. 23 is a flowchart illustrating an operation of a first access point according to an embodiment of the disclosure.

In operation 2300, the first access point may transmit a first action frame including periodic coordinated-time division multiple access (Co-TDMA) operation related information to a second access point.

In operation 2310, the first access point may receive a second action frame from the second access point in response to the first action frame.

In an embodiment, the periodic Co-TDMA operation may include an operation of periodically transferring a transmission opportunity (TXOP) between access points.

In an embodiment, the first access point may receive a first action frame including periodic coordinated-time division multiple access (Co-TDMA) operation related information from the second access point.

In an embodiment, the first access point may transmit a second action frame to the second access point in response to the first action frame. In an embodiment, the periodic Co-TDMA operation related information may include information about at least one of Co-TDMA operation related time information, Co-TDMA operation related frequency information, and Co-TDMA operation related channel access information.

In an embodiment, the periodic Co-TDMA operation related information may include an indicator indicating whether the Co-TDMA operation related time information, the Co-TDMA operation related frequency information, and the Co-TDMA operation related channel access information are periodic Co-TDMA operation related information.

In an embodiment, the periodic Co-TDMA operation related information may include information about at least one of: a request start time for receiving a TXOP transfer, a time interval for receiving a TXOP transfer, a minimum TXOP duration for receiving the TXOP transfer, and a maximum waiting time from the request start time until receiving the TXOP transfer.

In an embodiment, the periodic Co-TDMA operation related information may include information about at least one of: a minimum value of bandwidth of a TXOP that may be transferred to the first access point, an operating bandwidth in which the first access point is currently operating, information indicating whether the first access point may receive a transfer of a TXOP with a dynamic subchannel operation (DSO) operation, and bandwidth information operable when the first access point receives a transfer of a TXOP with a DSO operation.

In an embodiment, the periodic Co-TDMA operation related information may include information about at least one of: at least one EDCA parameter usable in a transferred TXOP, and an access category processable in a transferred TXOP.

In an embodiment, when the first action frame is a request frame and the second action frame is a response frame, the second action frame may include status information indicating whether the request for the periodic Co-TDMA operation related information is accepted.

In an embodiment, when the status information includes a value indicating preferred information proposed for periodic Co-TDMA operation, the second action frame may include periodic Co-TDMA operation related information.

In an embodiment, the periodic Co-TDMA operation related information may be included in a UHR operation related field, a multiple-access point (M-AP) operation related field, or a Co-TDMA operation related field of the first action frame.

In an embodiment, the periodic Co-TDMA operation related information may be identified by at least one of an M-AP Management Type field, an M-AP scheme field, and an M-AP agreement ID (M-AP MID) field of a field including the periodic Co-TDMA operation related information.

In an embodiment, the first access point may transmit a third action frame in response to the second action frame.

In an embodiment, the first action frame may include a request frame, the second action frame may include a response frame, and the third action frame may include a confirm frame.

In an embodiment, the first access point may transmit a fourth action frame in response to the third action frame.

In an embodiment, the fourth action frame may include an acknowledge frame.

FIG. 24 is a flowchart illustrating an operation of a second access point according to an embodiment of the disclosure.

In operation 2400, the second access point may receive a first action frame including periodic coordinated-time division multiple access (Co-TDMA) operation related information from a first access point.

In operation 2410, the second access point may transmit a second action frame to the first access point in response to the first action frame.

In an embodiment, the periodic Co-TDMA operation may include an operation of periodically transferring a transmission opportunity (TXOP) between access points.

In an embodiment, the second access point may transmit a first action frame including periodic coordinated-time division multiple access (Co-TDMA) operation related information to the first access point.

In an embodiment, the second access point may receive a second action frame from the first access point in response to the first action frame.

The size (e.g., byte/bit size) and/or position of each field included in the frame formats or element formats illustrated in the disclosure are merely examples for convenience of description, and the size and/or position of each field may be implemented with various values according to design specifications.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first access point (AP) in a wireless local area network (WLAN) communication system, the method comprising:
transmitting, to a second AP, a multi-AP coordination (MAPC) negotiation request frame for a coordinated-time division multiple access (Co-TDMA) agreement, wherein the MAPC negotiation request frame includes Co-TDMA operation related information; and
receiving, from the second AP, an MAPC negotiation response frame for the Co-TDMA agreement, in response to the MAPC negotiation request frame,
wherein the Co-TDMA operation related information includes bandwidth information of the first AP, and
wherein the bandwidth information of the first AP includes channel width information indicating basic service set (BSS) bandwidth of the first AP and information on a channel center frequency segment (CCFS) indicating a channel center frequency for the BSS bandwidth of the first AP.

2. The method of claim 1, wherein the bandwidth information of the first AP includes disabled subchannel bitmap information indicating a list of punctured subchannels within the BSS bandwidth of the first AP.

3. The method of claim 1, wherein the Co-TDMA operation indicates an operation of sharing a transmission opportunity (TXOP) between APs.

4. The method of claim 1, wherein the Co-TDMA operation related information includes information on at least one access category (AC) available for the first AP.

5. The method of claim 1, wherein the Co-TDMA operation related information further includes at least one of:
Co-TDMA operation related time information,
Co-TDMA operation related frequency information, or
Co-TDMA operation related channel access information.

6. The method of claim 5, wherein the Co-TDMA operation related information includes an indicator indicating whether the Co-TDMA operation related time information, the Co-TDMA operation related frequency information, and the Co-TDMA operation related channel access information are periodic Co-TDMA operation related information.

7. The method of claim 1, wherein the Co-TDMA operation related information includes information on at least one of:
a request start time for TXOP sharing,
a time interval for TXOP sharing,
a minimum TXOP duration for TXOP sharing, or
a maximum waiting time from the request start time until TXOP sharing.

8. The method of claim 1, wherein the Co-TDMA operation related information includes information on at least one of:
a minimum value of bandwidth of a TXOP that may be shared with the first access point,
information indicating whether sharing a TXOP with a dynamic subchannel operation (DSO) operation is allowed for the first access point, or
information on an operating bandwidth available when a TXOP with a DSO operation is shared with the first access point.

9. The method of claim 1, wherein the Co-TDMA operation related information includes information about at least one of:
at least one enhanced distributed channel access (EDCA) related parameter usable in a shared TXOP, or
an access category processable in a shared TXOP.

10. The method of claim 1,
wherein the MAPC negotiation response frame includes status information indicating whether a request for the Co-TDMA operation related information is accepted, and
wherein, in case that the MAPC negotiation response frame includes a value indicating preferred information proposed for a Co-TDMA operation, the MAPC negotiation response frame includes Co-TDMA operation related information.

11. The method of claim 1, wherein the Co-TDMA operation related information is identified by an MAPC scheme related field of the MAPC negotiation request frame.

12. A method performed by a second access point (AP) in a wireless local area network (WLAN) communication system, the method comprising:
receiving, from a first AP, a multi-AP coordination (MAPC) negotiation request frame for a coordinated-time division multiple access (Co-TDMA) agreement, wherein the MAPC negotiation request frame includes Co-TDMA operation related information; and
transmitting, to the first AP, an MAPC negotiation response frame for the Co-TDMA agreement, in response to the MAPC negotiation request frame,
wherein the Co-TDMA operation related information includes bandwidth information of the first AP, and
wherein the bandwidth information of the first AP includes channel width information indicating basic service set (BSS) bandwidth of the first AP and information on a channel center frequency segment (CCFS) indicating a channel center frequency for the BSS bandwidth of the first AP.

13. The method of claim 12, wherein the bandwidth information of the first AP includes disabled subchannel bitmap information indicating a list of punctured subchannels within the BSS bandwidth of the first AP.

14. The method of claim 12, wherein the Co-TDMA operation indicates an operation of sharing a transmission opportunity (TXOP) between APs.

15. The method of claim 12, wherein the Co-TDMA operation related information includes information on at least one access category (AC) available for the first AP.

16. The method of claim 12,
wherein the MAPC negotiation response frame includes status information indicating whether a request for the Co-TDMA operation related information is accepted, and
wherein, in case that the MAPC negotiation response frame includes a value indicating preferred information proposed for a Co-TDMA operation, the MAPC negotiation response frame includes Co-TDMA operation related information.

17. The method of claim 12, wherein the Co-TDMA operation related information is identified by an MAPC scheme related field of the MAPC negotiation request frame.

18. A first access point (AP) in a wireless local area network (WLAN) communication system, the first AP comprising:
at least one transceiver;
at least one processor communicatively coupled to the at least one transceiver; and
at least one memory, communicatively coupled to the at least one processor, storing instructions executable by the at least one processor individually or in any combination to cause the first AP to:
transmit, to a second AP, a multi-AP coordination (MAPC) negotiation request frame for a coordinated-time division multiple access (Co-TDMA) agreement, wherein the MAPC negotiation request frame includes Co-TDMA operation related information, and
receive, from the second AP, an MAPC negotiation response frame for the Co-TDMA agreement, in response to the MAPC negotiation request frame,
wherein the Co-TDMA operation related information includes bandwidth information of the first AP, and
wherein the bandwidth information of the first AP includes channel width information indicating basic service set (BSS) bandwidth of the first AP and information on a channel center frequency segment (CCFS) indicating a channel center frequency for the BSS bandwidth of the first AP.

19. The first AP of claim 18, wherein the bandwidth information of the first AP includes disabled subchannel bitmap information indicating a list of punctured subchannels within the BSS bandwidth of the first AP.

20. A second access point (AP) in a wireless local area network (WLAN) communication system, the second AP comprising:
at least one transceiver;
at least one processor communicatively coupled to the at least one transceiver; and
at least one memory, communicatively coupled to the at least one processor, storing instructions executable by the at least one processor individually or in any combination to cause the second AP to:
receive, from a first AP, a multi-AP coordination (MAPC) negotiation request frame for a coordinated-time division multiple access (Co-TDMA) agreement, wherein the MAPC negotiation request frame includes Co-TDMA operation related information, and
transmit, to the first AP, an MAPC negotiation response frame for the Co-TDMA agreement, in response to the MAPC negotiation request frame,
wherein the Co-TDMA operation related information includes bandwidth information of the first AP, and
wherein the bandwidth information of the first AP includes channel width information indicating basic service set (BSS) bandwidth of the first AP and information on a channel center frequency segment (CCFS) indicating a channel center frequency for the BSS bandwidth of the first AP.
